(19) United States
(12) Patent Application Publication
(10) Pub. No.: US 2026/0003405 A1
(43) Pub. Date: Jan. 1, 2026

(54) ELECTRONIC DEVICE

(71) Applicant: SAMSUNG DISPLAY CO., LTD., YONGIN-SI (KR)

(72) Inventors: CHANHUI HAN, Yongin-si (KR); TAE-CHANG KIM, Yongin-si (KR); SANGHYO PARK, Yongin-si (KR); HYE-RYOUNG PARK, Yongin-si (KR)

(21) Appl. No.: 19/192,878

(22) Filed: Apr. 29, 2025

(30) Foreign Application Priority Data
Jun. 26, 2024 (KR) 10-2024-0083260
Aug. 7, 2024 (KR) 10-2024-0105319

(51) Int. Cl. G06F 1/16

(52) U.S. Cl. CPC G06F 1/1681; G06F 1/1616; G06F 1/1656

(57) ABSTRACT

An electronic device includes a display device foldable with respect to a folding axis extending in a second direction, and a hinge mechanism including accommodation grooves accommodating the display device. The hinge mechanism includes housings defining the accommodation grooves and disposed in a first direction intersecting the second direction, a first hinge disposed between the housings and defining a first rotating axis extending in the second direction, a second hinge disposed between the housings and defining a second rotating axis extending in the second direction, main plates disposed inside the accommodation grooves, coupled to the first hinge, and rotatable about the first rotating axis, and moving plates disposed on the main plates inside the accommodation grooves, coupled to the second hinge, and rotatable about the second rotating axis. Among the first rotating axis and the second rotating axis, the first rotating axis is disposed closer to the display device.

### CROSS-REFERENCE TO RELATED APPLICATIONS

This application claims priority under 35 U.S.C. § 119 to Korean Patent Application No. 10-2024-0083260 filed on Jun. 26, 2024, and Korean Patent Application No. 10-2024-0105319 filed on Aug. 7, 2024, the disclosures of which are incorporated by reference herein in their entireties.

### TECHNICAL FIELD

Embodiments of the present disclosure described herein relate to an electronic device, and more particularly, an electronic device including a hinge mechanism.

### DISCUSSION OF RELATED ART

Electronic devices, such as smartphones, digital cameras, laptop computers, navigation devices, and smart televisions, commonly include display devices to present images to users. These display devices generate images and deliver them through their screens for user interaction.

In recent years, advancements in display technology have led to the development of various innovative display types. For example, flexible display devices capable of expanding outward through sliding or rolling mechanisms have been introduced. These flexible displays, which can take on different shapes, offer improved portability and user convenience.

### SUMMARY

Embodiments of the present disclosure provide an electronic device having an increased area of a display surface and improved folding reliability.

According to an embodiment of the present application, an electronic device includes a display device configured to be folded or unfolded with respect to a folding axis extending in a second direction, and a hinge mechanism in which a plurality of accommodation grooves configured to accommodate the display device are defined. The hinge mechanism includes a plurality of housings defining the accommodation grooves and disposed in a first direction intersecting the second direction, a first hinge disposed between the housings and defining a first rotating axis extending in the second direction, a second hinge disposed between the housings and defining a second rotating axis extending in the second direction, a plurality of main plates disposed inside the accommodation grooves, coupled to the first hinge, and configured to rotate about the first rotating axis, and a plurality of moving plates disposed on the main plates inside the accommodation grooves, coupled to the second hinge, and configured to rotate about the second rotating axis. Among the first rotating axis and the second rotating axis, the first rotating axis is disposed closer to the display device.

According to an embodiment of the present application, an electronic device includes a display device including a folding area configured to be folded or unfolded with respect to a folding axis extending in a second direction, and a plurality of non-folding areas disposed on both sides of the folding area opposite to each other in a first direction intersecting the second direction, and a hinge mechanism disposed below the display device. The hinge mechanism includes a first hinge overlapping the folding area and defining a first rotating axis extending in the second direction, a second hinge overlapping the folding area and defining a second rotating axis extending in the second direction below the first rotating axis, a plurality of housings defining a plurality of accommodation grooves configured to accommodate the display device and connected to the first hinge such that the housings rotate about the first rotating axis, and a plurality of moving plates disposed between the display device and the housings and connected to the second hinge such that the moving plates rotate about the second rotating axis.

According to an embodiment of the present disclosure, an electronic device includes a display device configured to be folded or unfolded with respect to a folding axis extending in a second direction, a power supply configured to provide power to the display device, and a hinge mechanism in which a plurality of accommodation grooves configured to accommodate the display device are defined. The hinge mechanism includes a plurality of housings defining the accommodation grooves and disposed in a first direction intersecting the second direction, a first hinge disposed between the housings and defining a first rotating axis extending in the second direction, a second hinge disposed between the housings and defining a second rotating axis extending in the second direction, a plurality of main plates disposed inside the accommodation grooves, coupled to the first hinge, and configured to rotate about the first rotating axis, and a plurality of moving plates disposed on the main plates inside the accommodation grooves, coupled to the second hinge, and configured to rotate about the second rotating axis. Among the first rotating axis and the second rotating axis, the first rotating axis is disposed closer to the display device.

### BRIEF DESCRIPTION OF THE DRAWINGS

The above and other objects and features of the present disclosure will become more apparent by describing in detail embodiments thereof with reference to the accompanying drawings.

FIG. 1 is a perspective view of an electronic device according to an embodiment of the present disclosure.

FIG. 2 is a view illustrating a folded state of the electronic device illustrated in FIG. 1.

FIG. 3 is an exploded perspective view of the electronic device illustrated in FIG. 1.

FIG. 4 is a block diagram of the electronic device illustrated in FIG. 3.

FIG. 5 is a schematic cross-sectional view of a display module illustrated in FIG. 3.

FIG. 6 is a view illustrating a cross section of a display panel illustrated in FIG. 5.

FIG. 7 is a plan view of the display module illustrated in FIG. 3.

FIG. 8 is a view illustrating a cross section of an electronic panel corresponding to any one pixel illustrated in FIG. 7.

FIG. 9A is a cross-sectional view along line II-II′ illustrated in FIG. 7.

FIG. 9B is a view illustrating a state in which a bending area illustrated in FIG. 9A is bent.

FIG. 10 is an exploded perspective view of a hinge module illustrated in FIG. 3.

FIG. 11 is a view for describing main plates and first hinges illustrated in FIG. 10.

FIGS. 12A and 12B are views for describing coupling between the main plates, the first hinges, and a housing assembly.

FIG. 13 is a view for describing coupling between moving plates and a second hinge.

FIGS. 14A and 14B are cross-sectional views of the moving plates and the second hinge corresponding to line III-III′ illustrated in FIG. 13.

FIG. 15A is a perspective view of the second hinge and the moving plates coupled to the housing assembly.

FIGS. 15B and 15C are cross-sectional views of the hinge module corresponding to line IV-IV′ illustrated in FIG. 15A.

FIGS. 16A and 16B are cross-sectional views of the electronic device corresponding to line I-I′ illustrated in FIG. 1.

FIGS. 17A and 17B are views for describing the first hinges according to an embodiment of the present disclosure.

FIGS. 17C and 17D are views for describing first rotating axis and second rotating axis.

FIG. 18 is a block diagram illustrating an electronic device according to an embodiment.

### DETAILED DESCRIPTION

Embodiments of the present disclosure will be described more fully hereinafter with reference to the accompanying drawings. Like reference numerals may refer to like elements throughout the accompanying drawings.

The expression “and/or” includes one or more combinations which associated components are capable of defining.

Although the terms “first”, “second”, etc. may be used to describe various components, the components should not be limited by the terms. The terms are only used to distinguish one component from another component. For example, without departing from the scope of the present disclosure, a first component may be referred to as a second component, and similarly, the second component may be also referred to as the first component. Singular expressions include plural expressions unless clearly otherwise indicated in the context.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The terms that are relative in concept are described based on a direction illustrated in drawings.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

It should be understood that descriptions of features or aspects within each embodiment should typically be considered as available for other similar features or aspects in other embodiments, unless the context clearly indicates otherwise.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art, for example, within ±30%, 20%, 10% or 5% of the stated value. Further, it is to be understood that while parameters may be described herein as having “about” a certain value, according to embodiments, the parameter may be exactly the certain value or approximately the certain value within a measurement error as would be understood by a person having ordinary skill in the art.

It will be understood that the terms “include”, “comprise”, “have”, etc. specify the presence of features, numbers, steps, operations, elements, or components, described in the specification, or a combination thereof, and do not exclude in advance the presence or additional possibility of one or more other features, numbers, steps, operations, elements, or components or a combination thereof.

Embodiments of the present application provide a foldable electronic device having a structural design that improves folding reliability and increases display area usability. Embodiments utilize a hinge module including a first rotation axis positioned above a second rotation axis, with the housing coupled to the upper part of the display device rotating around the first axis, and a moving plate coupled to the lower part rotating around the second axis. This dual-axis configuration may compensate for slip in the display device during folding, improving stability and alignment. Additionally, embodiments may integrate a window module with the housing and increase the display surface area, providing a more expansive and seamless viewing experience while maintaining structural integrity.

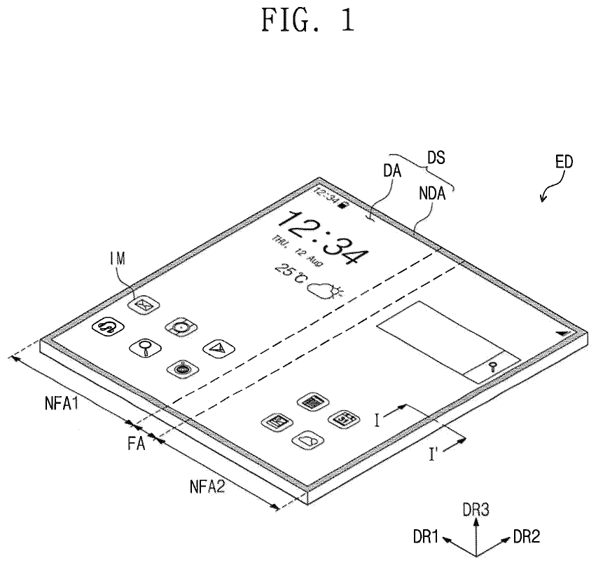

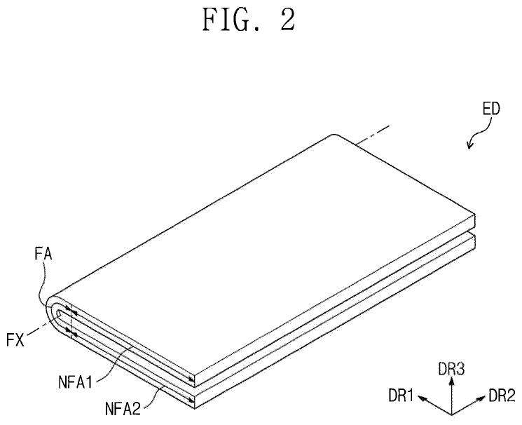

FIG. 1 is a perspective view of an electronic device according to an embodiment of the present disclosure. FIG. 2 is a view illustrating a folded state of the electronic device illustrated in FIG. 1.

Referring to FIG. 1, an electronic device ED according to an embodiment of the present disclosure may have a rectangular shape having short sides extending in a first direction DR1 and long sides extending in a second direction DR2 intersecting the first direction DR1. The short sides are relatively short compared to the long sides, and the long sides are relatively long compared to the short sides. However, the present disclosure is not limited thereto. For example, according to embodiments, the electronic device ED may have various shapes such as a circular shape and a polygonal shape. The electronic device ED may be flexible.

Hereinafter, a direction substantially perpendicular to a plane defined by the first direction DR1 and the second direction DR2 is defined as a third direction DR3. Further, in the specification, the wording “when viewed on a plane” may be defined as a state of being viewed from the third direction DR3.

The electronic device ED may include a folding area FA and a plurality of non-folding areas NFA1 and NFA2. The non-folding areas NFA1 and NFA2 may include the first non-folding area NFA1 and the second non-folding area NFA2. The folding area FA may be disposed between the first non-folding area NFA1 and the second non-folding area NFA2. The folding area FA, the first non-folding area NFA1, and the second non-folding area NFA2 may be disposed in the first direction DR1. For example, the folding area FA, the first non-folding are NFA1, and the second non-folding area NFA2 may be disposed adjacent to each other in the first direction DR1.

Although one folding area FA and two non-folding areas NFA1 and NFA2 are illustrated in FIG. 1, the numbers of folding areas FA and the non-folding areas NFA1 and NFA2 are not limited thereto. For example, according to embodiments, the electronic device ED may include more than two non-folding areas and a plurality of folding areas disposed between the non-folding areas.

An upper surface of the electronic device ED may be defined as a display surface DS, which lies within a plane defined by the first direction DR1 and the second direction DR2. Images IM generated by the electronic device ED may be provided to a user through the display surface DS.

The display surface DS may include a display area DA and a non-display area NDA disposed around the display area DA. The display area DA is an area in which an image is displayed, and the non-display area NDA is an area in which the image is not displayed. The non-display area NDA may surround the display area DA and may define an edge of the electronic device ED printed in a predetermined color. For example, the non-display area NDA may correspond to a bezel of the electronic device ED.

Referring to FIG. 2, the electronic device ED may be a foldable electronic device ED that is folded or unfolded. For example, the folding area FA may be bent with respect to a folding axis FX extending in the second direction DR2, and thus, the electronic device ED may be folded. The folding axis FX may be defined as a long axis parallel to the long sides of the electronic device ED. When the electronic device ED is folded, the first non-folding area NFA1 and the second non-folding area NFA2 may face each other, and the electronic device ED may be folded in an “in-folded” state, in which the display surface DS is protected and is not exposed to the outside. However, the present disclosure is not limited thereto. For example, according to embodiments, the electronic device ED may be folded in an “out-folded” state, in which the display surface DS is exposed to the outside about the folding axis FX. Further, according to embodiments, the electronic device ED may be capable of being both in the in-folded state and the out-folded state.

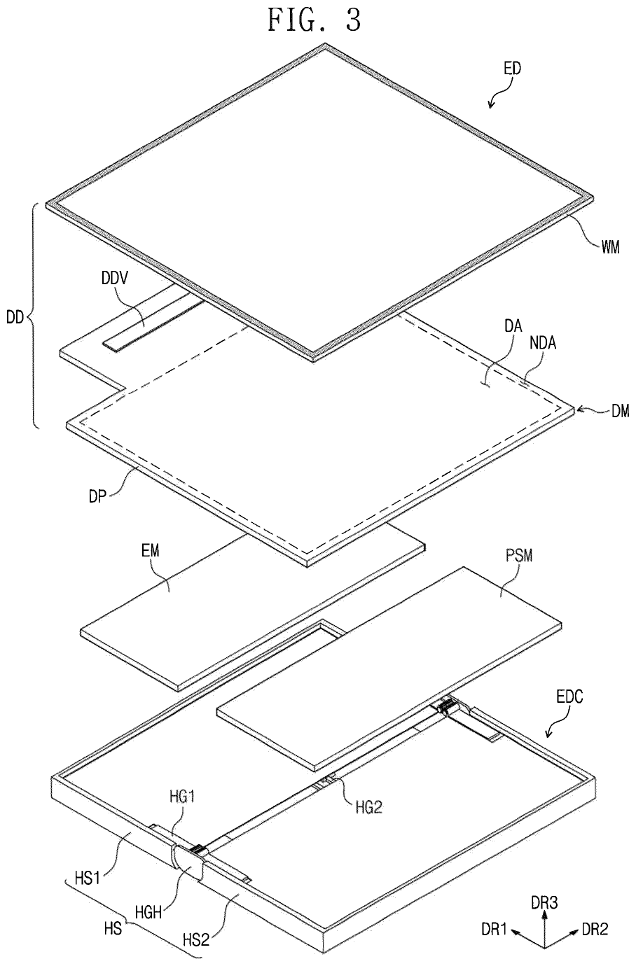

FIG. 3 is an exploded perspective view of the electronic device illustrated in FIG. 1.

Referring to FIG. 3, the electronic device ED may include a display device DD, an electronic module EM, a power supply module PSM, and a hinge module EDC. The hinge module EDC may also be referred to as a hinge mechanism. The electronic device ED may further include a mechanical structure (e.g., a hinge) that controls a folding operation of the display device DD. The hinge will be described in further detail below.

The display device DD may generate an image and sense an external input. The display device DD may include a window module WM and a display module DM. The window module WM may provide a front surface of the electronic device ED. The window module WM may be disposed on the display module DM and may protect the display module DM. The window module WM may transmit light generated by the display module DM and provide the light to the user.

The display module DM may include a display panel DP. Although FIG. 3 illustrates only the display panel DP among laminated structures of the display module DM, the present disclosure is not limited thereto. For example, according to embodiments, the display module DM may further include a plurality of components disposed on an upper side and a lower side of the display panel DP. A detailed laminated structure of the display module DM will be described in further detail below. The display panel DP may include a display area DA and a non-display area NDA corresponding to the display area DA and the non-display area NDA of the electronic device ED illustrated in FIG. 1.

The display module DM may include a data driver DDV disposed in the non-display area NDA of the display panel DP. The data driver DDV may be directly manufactured in the form of a circuit chip and mounted in the non-display area NDA. However, the present disclosure is not limited thereto. For example, according to embodiments, the data driver DDV may be mounted on a flexible circuit board connected to the display panel DP.

The electronic module EM and the power supply module PSM may be disposed inside the hinge module EDC. FIG. 3 illustrates a state in which the electronic module EM and the power supply module PSM are exposed to the outside from the hinge module EDC. According to embodiments, the electronic module EM and the power supply module PSM may be connected to each other through a separate flexible circuit board. The electronic module EM may control an operation of the display device DD. The power supply module PSM may supply power to the electronic module EM.

The hinge module EDC may accommodate the display device DD, the electronic module EM, and the power supply module PSM. The hinge module EDC may include first and second housings HS1 and HS2 used to fold the display device DD. The first and second housings HS1 and HS2 may extend in the second direction DR2 and may be disposed in the first direction DR1. For example, the first and second housings HS1 and HS2 may extend lengthwise in the second direction DR2 and may disposed adjacent to each other in the first direction DR1.

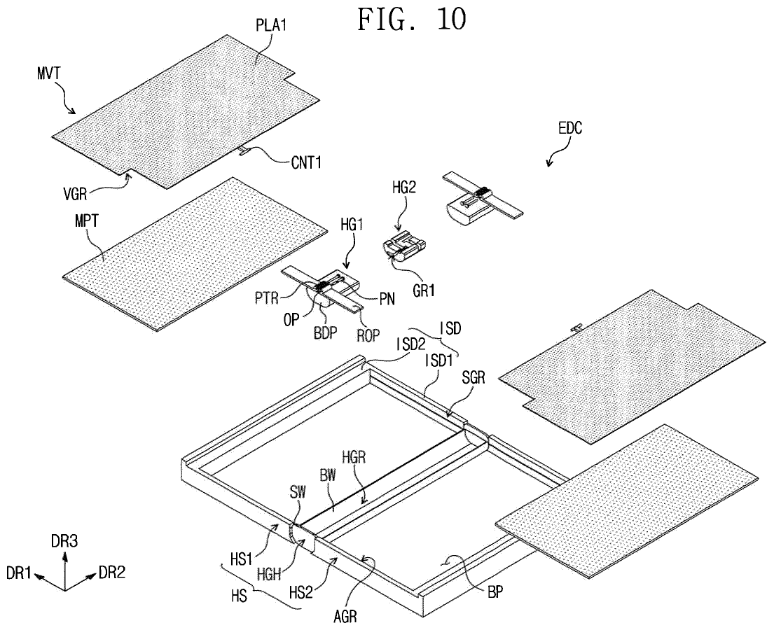

The hinge module EDC may include a housing assembly HS. The housing assembly HS may include the first housing HS1 and the second housing HS2 spaced apart from each other in the first direction DR1 and a hinge housing HGH disposed between the first housing HS1 and the second housing HS2. The hinge module EDC may further include hinges HG1 and HG2 that connect the first and second housings HS1 and HS2, a plurality of main plates MPT (see FIG. 10), and a plurality of moving plates MVT. The hinges HG1 and HG2, the main plates MPT, and the moving plates MVT will be described in further detail below.

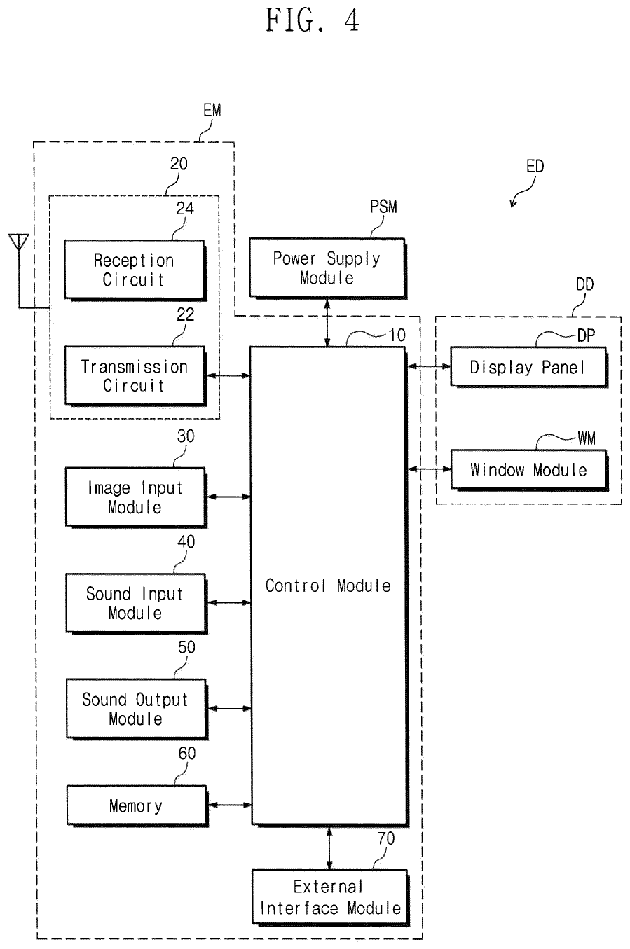

FIG. 4 is a block diagram of the electronic device illustrated in FIG. 3.

Referring to FIG. 4, the electronic device ED may include the electronic module EM, the power supply module PSM, and the display device DD. The electronic module EM may include a control module 10, a wireless communication module 20, an image input module 30, a sound input module 40, a sound output module 50, a memory 60, an external interface module 70, and the like. The modules may be mounted on a circuit board or may be electrically connected through a flexible circuit board. The electronic module EM may be electrically connected to the power supply module PSM.

The control module 10 may control an overall operation of the electronic device ED. For example, the control module 10 may activate or deactivate the display device DD in accordance with a user input. The control module 10 may control the image input module 30, the sound input module 40, the sound output module 50, and the like in accordance with the user input. The control module 10 may include at least one microprocessor.

The wireless communication module 20 may transmit/receive a wireless signal to/from another terminal using, for example, a BLUETOOTH connection or a WI-FI connection. The wireless communication module 20 may transmit/receive a voice signal using a general communication line. The wireless communication module 20 may include a transmission circuit 22 that modulates and transmits a signal to be transmitted, and a reception circuit 24 that demodulates a received signal.

The image input module 30 may process an image signal and convert the image signal into image data that may be displayed on the display device DD. The sound input module 40 may receive an external sound signal through a microphone in a recording mode or a voice recognition mode and convert the received external sound signal into electrical voice data. The sound output module 50 may convert sound data received from the wireless communication module 20 or sound data stored in the memory 60 and output the converted sound data to the outside.

The external interface module 70 may serve as an interface connected to, for example, an external charger, a wired/wireless data port, and a card socket (e.g., a memory card, a subscriber identity module (SIM)/user interface model (UIM) card).

The power supply module PSM may supply power utilized for an overall operation of the electronic device ED. The power supply module PSM may include a general battery device.

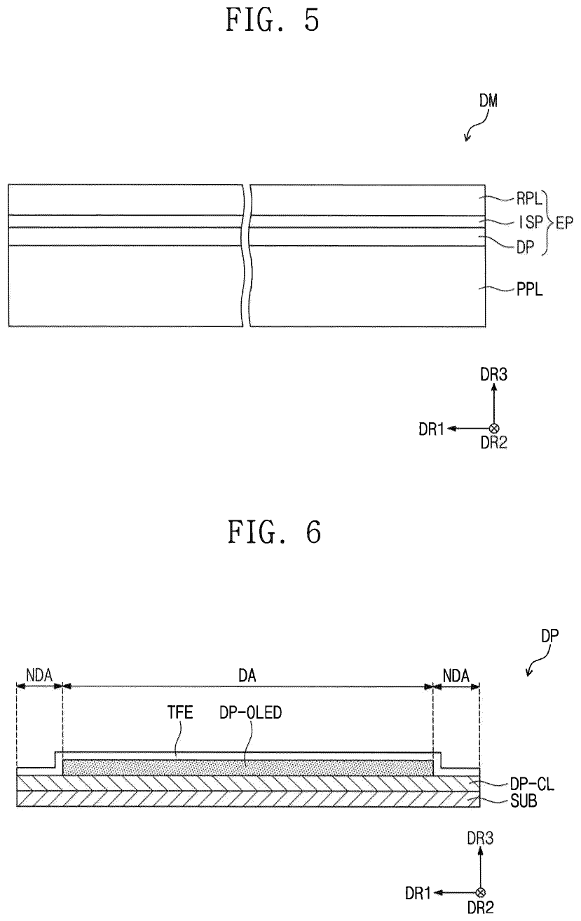

FIG. 5 is a schematic cross-sectional view of a display module illustrated in FIG. 3.

Referring to FIG. 5, the display module DM may include the display panel DP, an input sensing unit ISP disposed on the display panel DP, a reflection preventing layer RPL disposed on the input sensing unit ISP, and a panel protecting layer PPL disposed under the display panel DP. The display panel DP may be a flexible display panel. For example, the display panel DP may include a flexible substrate and a plurality of elements disposed on the flexible substrate.

The display panel DP according to an embodiment of the present disclosure may be a light emitting display panel, but the present disclosure is not particularly limited thereto. For example, according to embodiments, the display panel DP may be an organic light emitting display panel or an inorganic light emitting display panel. A light emitting layer of the organic light emitting display panel may include an organic light emitting material. A light emitting layer of the inorganic light emitting display panel may include, for example, a quantum dot, a quantum rod, or the like. Hereinafter, the display panel DP will be described as the organic light emitting display panel.

The input sensing unit ISP may include a plurality of sensor parts that sense an external input in a capacitive manner. The input sensing unit ISP may be directly formed on the display panel DP when the display module DM is manufactured.

The reflection preventing layer RPL may be disposed on the input sensing unit ISP. The reflection preventing layer RPL may be directly formed on the input sensing unit ISP when the display module DM is manufactured. The reflection preventing layer RPL may be defined as an external light reflection preventing film. The reflection preventing layer RPL may reduce a reflectance of an external light input from an upper side of the display device DD toward the display panel DP.

The input sensing unit ISP may be directly formed on the display panel DP, and the reflection preventing layer RPL may be directly formed on the input sensing unit ISP. However, the present disclosure is not limited thereto. For example, according to embodiments, the input sensing unit ISP may be separately manufactured and attached to the display panel DP by an adhesive layer, and the reflection preventing layer RPL may be separately manufactured and attached to the input sensing unit ISP by an adhesive layer.

The display panel DP, the input sensing unit ISP, and the reflection preventing layer RPL may be defined as an electronic panel EP.

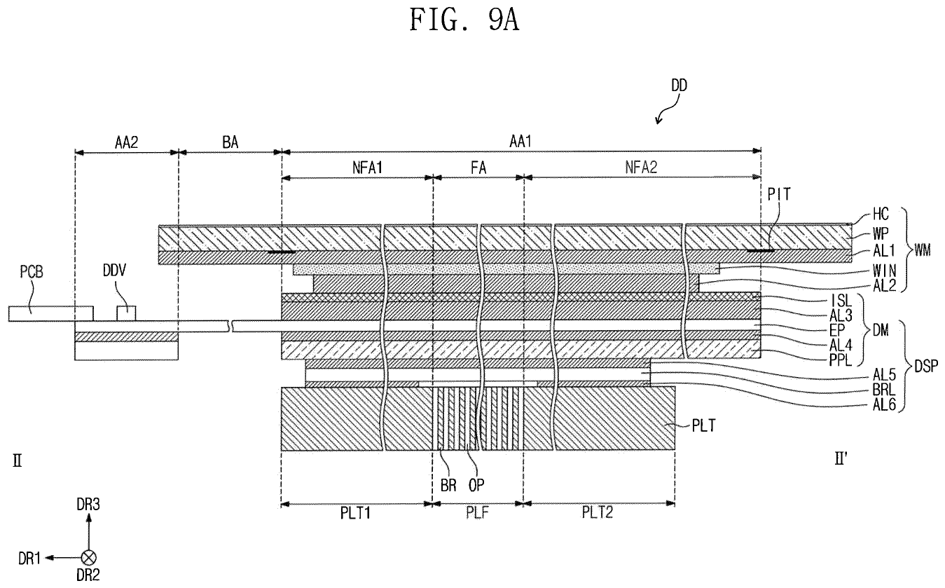

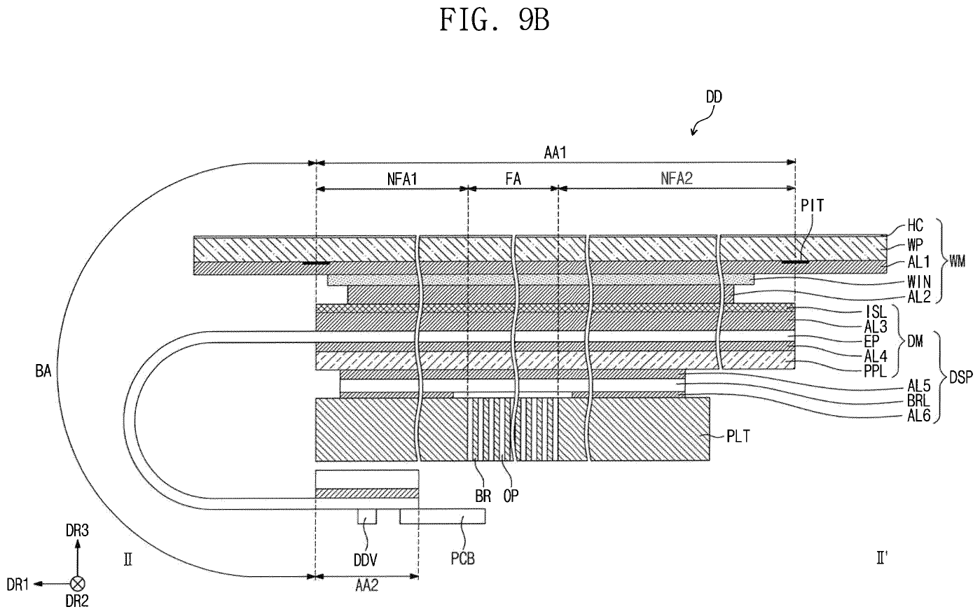

The panel protecting layer PPL may be disposed under the display panel DP. The panel protecting layer PPL may protect a lower portion of the display panel DP. The panel protecting layer PPL may include a flexible plastic material. For example, the panel protecting layer PPL may include polyethylene terephthalate (PET). FIG. 5 illustrates the panel protecting layer PPL as one integrally formed layer, but the panel protecting layer PPL may include two layers spaced apart from each other. This will be described in detail in FIG. 9A.

FIG. 6 is a view illustrating a cross section of a display panel illustrated in FIG. 5.

FIG. 6 illustrates a cross section of the display panel DP when viewed in the second direction DR2.

Referring to FIG. 6, the display panel DP may include a substrate SUB, a circuit element layer DP-CL disposed on the substrate SUB, a display element layer DP-OLED disposed on the circuit element layer DP-CL, and a thin film encapsulation layer TFE disposed on the display element layer DP-OLED.

The substrate SUB may include the display area DA and the non-display area NDA disposed around the display area DA. The substrate SUB may include a flexible plastic material such as, for example, glass or polyimide (PI). The display element layer DP-OLED may be disposed on the display area DA.

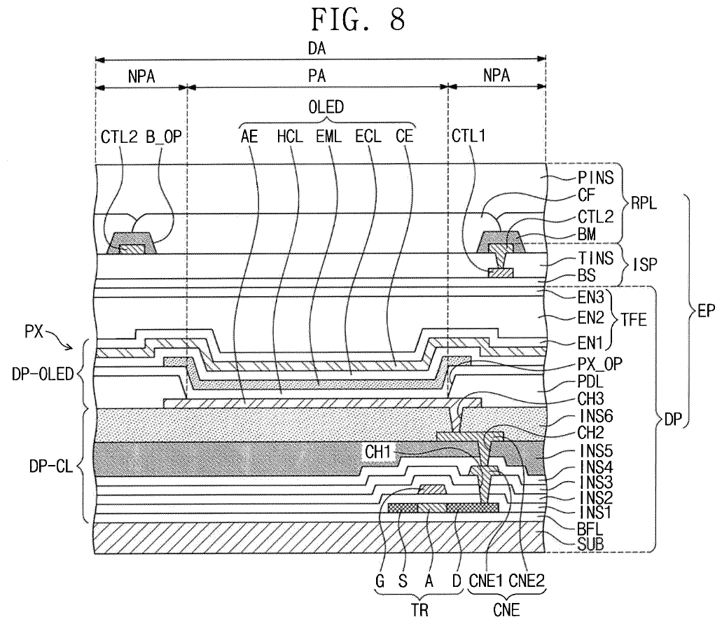

A plurality of pixels may be disposed in the circuit element layer DP-CL and the display element layer DP-OLED. Each of the pixels may include a transistor disposed in the circuit element layer DP-CL and a light emitting element disposed in the display element layer DP-OLED and connected to the transistor. A configuration of the pixel will be described in further detail in FIG. 8.

The thin film encapsulation layer TFE may be disposed on the circuit element layer DP-CL and may cover the display element layer DP-OLED. The thin film encapsulation layer TFE may protect the pixels from, for example, moisture, oxygen, and external foreign substances.

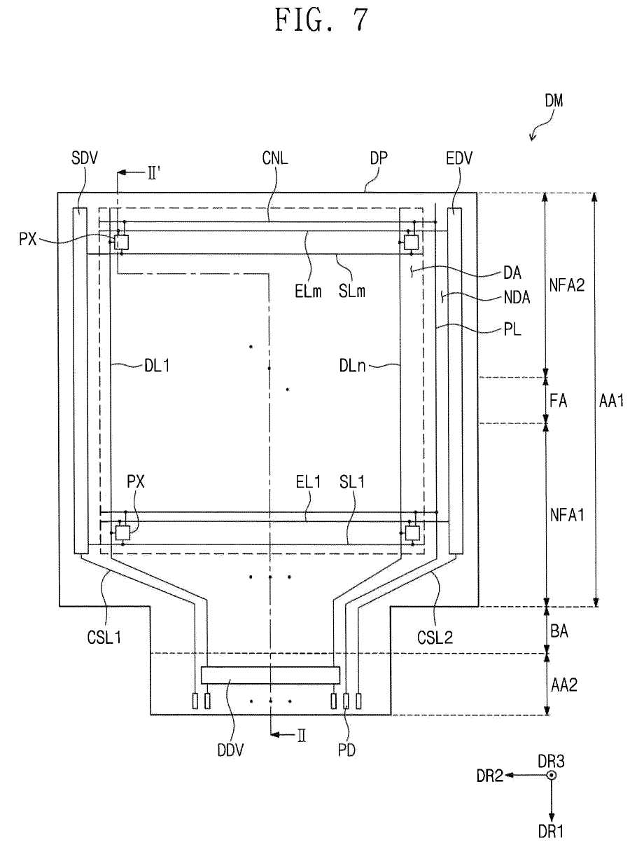

FIG. 7 is a plan view of the display module illustrated in FIG. 3.

Referring to FIG. 7, the display module DM may include the display panel DP, a scan driver SDV, the data driver DDV, and an emission driver EDV.

The display panel DP may include a first area AA1, a second area AA2, and a bending area BA disposed between the first area AA1 and the second area AA2. The bending area BA may extend in the second direction DR2, and the first area AA1, the bending area BA, and the second area AA2 may be disposed in the first direction DR1.

The first area AA1 may include the display area DA and the non-display area NDA disposed around the display area DA. The non-display area NDA may surround the display area DA. The display area DA may be an area in which an image is displayed, and the non-display area NDA may be an area in which an image is not displayed. The second area AA2 and the bending area BA may be areas that do not display images.

The first area AA1 may include the first non-folding area NFA1, the second non-folding area NFA2, and the folding area FA disposed between the first non-folding area NFA1 and the second non-folding area NFA2 when viewed in the second direction DR2.

The display panel DP may include the plurality of pixels PX, a plurality of scan lines SL1 to SLm, a plurality of data lines DL1 to DLn, a plurality of light emitting lines EL1 to ELm, a first control line CSL1, a second control line CSL2, a power line PL, a plurality of connection lines CNL, and a plurality of pads PD, where each of “m” and “n” is a positive integer. The pixels PX may be disposed in the display area DA and connected to the scan lines SL1 to SLm, the data lines DL1 to DLn, and the light emitting lines EL1 to ELm.

The scan driver SDV and the emission driver EDV may be disposed in the non-display area NDA. The scan driver SDV and the emission driver EDV may be disposed in the non-display area NDA adjacent to both sides of the first area AA1, which are opposite to each other in the second direction DR2. The data driver DDV may be disposed in the second area AA2. The data driver DDV may be manufactured in the form of an integrated circuit chip and mounted on the second area AA2.

The scan lines SL1 to SLm may extend in the second direction DR2 and may be connected to the scan driver SDV. The data lines DL1 to DLn may extend in the first direction DR1 and may be connected to the data driver DDV via the bending area BA. The light emitting lines EL1 to ELm may extend in the second direction DR2 and may be connected to the emission driver EDV.

The power line PL may extend in the first direction DR1 and may be disposed in the non-display area NDA. The power line PL may be disposed between the display area DA and the emission driver EDV, but the present disclosure is not limited thereto. For example, according to embodiments, the power line PL may be disposed between the display area DA and the scan driver SDV.

The power line PL may extend to the second area AA2 via the bending area BA. The power line PL may extend toward a lower end of the second area AA2 when viewed on a plane. The power line PL may receive a driving voltage.

The connection lines CNL may extend in the second direction DR2 and may be disposed in the first direction DR1. The connection lines CNL may be connected to the power line PL and the pixels PX. The driving voltage may be applied to the pixels PX through the power line PL and the connection lines CNL connected to each other.

The first control line CSL1 may be connected to the scan driver SDV and may extend toward a lower end of the second area AA2 via the bending area BA. The second control line CSL2 may be connected to the emission driver EDV and may extend toward the lower end of the second area AA2 via the bending area BA. The data driver DDV may be disposed between the first control line CSL1 and the second control line CSL2.

When viewed on a plane, the pads PD may be disposed adjacent to the lower end of the second area AA2. The data driver DDV, the power line PL, the first control line CSL1, and the second control line CSL2 may be connected to the pads PD.

The data lines DL1 to DLn may be connected to the corresponding pads PD through the data driver DDV. For example, the data lines DL1 to DLn may be connected to the data driver DDV, and the data driver DDV may be connected to the pads PD respectively corresponding to the data lines DL1 to DLn.

According to embodiments, a printed circuit board may be connected to the pads PD, and a timing controller and a voltage generator may be disposed on the printed circuit board. The timing controller may be manufactured as an integrated circuit chip and mounted on the printed circuit board. The timing controller and the voltage generator may be connected to the pads PD through the printed circuit board.

The timing controller may control operations of the scan driver SDV, the data driver DDV, and the emission driver EDV. The timing controller may generate a scan control signal, a data control signal, and a light emitting control signal in response to control signals received from an external unit. The voltage generator may generate a driving voltage.

The scan control signal may be provided to the scan driver SDV through the first control line CSL1. The light emitting control signal may be provided to the emission driver EDV through the second control line CSL2. The data control signal may be provided to the data driver DDV. The timing controller may receive image signals from an external unit, convert data formats of the image signals such that the data formats satisfy interface specifications with the data driver DDV, and provide the converted image signals to the data driver DDV.

The scan driver SDV may generate a plurality of scan signals in response to the scan control signal. The scan signals may be applied to the pixels PX through the scan lines SL1 to SLm. The scan signals may be sequentially applied to the pixels PX.

The data driver DDV may generate a plurality of data voltages corresponding to the image signals in response to the data control signal. The data voltages may be applied to the pixels PX through the data lines DL1 to DLn. The emission driver EDV may generate a plurality of light emitting signals in response to the light emitting control signal. The light emitting signals may be applied to the pixels PX through the light emitting lines EL1 to ELm.

The pixels PX may receive the data voltages in response to the scan signals. The pixels PX may display an image by emitting lights having luminances corresponding to the data voltages in response to the light emitting signals. Light emitting times of the pixels PX may be controlled by the light emitting signals.

FIG. 8 is a view illustrating a cross section of an electronic panel corresponding to any one pixel illustrated in FIG. 7.

Referring to FIG. 8, the pixel PX may include a transistor TR and a light emitting element OLED. The light emitting element OLED may include a first electrode AE (or an anode), a second electrode CE (or a cathode), a hole control layer HCL, an electron control layer ECL, and a light emitting layer EML.

The transistor TR and the light emitting element OLED may be disposed on the substrate SUB. Although one transistor TR is illustrated in FIG. 8, the present disclosure is not limited thereto. For example, according to embodiments, the pixel PX may include a plurality of transistors and at least one capacitor that drive the light emitting element OLED.

The display area DA may include a light emitting area PA corresponding to each of the pixels PX and a non-light emitting area NPA disposed around the light emitting area PA. The light emitting element OLED may be disposed in the light emitting area PA.

A buffer layer BFL may be disposed on the substrate SUB. The buffer layer BFL may be an inorganic layer. A semiconductor pattern may be disposed on the buffer layer BFL. The semiconductor pattern may include, for example, polysilicon, amorphous silicon, or a metal oxide.

The semiconductor pattern may be doped with an N-type dopant or a P-type dopant. The semiconductor pattern may include a high-doped area and a low-doped area. Conductivity of the high-doped area is higher than that of the low-doped area, and the high-doped area may substantially serve as a source electrode and a drain electrode of the transistor TR. The low-doped area may substantially correspond to an active area (or a channel) of the transistor.

A source area S, an active area A, and a drain area D of the transistor TR may be formed from the semiconductor pattern. A first insulating layer INS1 may be disposed on the semiconductor pattern. A gate G of the transistor TR may be disposed on the first insulating layer INS1. A second insulating layer INS2 may be disposed on the gate G. A third insulating layer INS3 may be disposed on the second insulating layer INS2.

A connection electrode CNE may include a first connection electrode CNE1 and a second connection electrode CNE2 that connect the transistor TR and the light emitting element OLED. The first connection electrode CNE1 may be disposed on the third insulating layer INS3 and may be connected to the drain area D through a first contact hole CH1 defined by the first insulating layer INS1, the second insulating layer INS2, and the third insulating layer INS3.

A fourth insulating layer INS4 may be disposed on the first connection electrode CNE1. A fifth insulating layer INS5 may be disposed on the fourth insulating layer INS4. The second connection electrode CNE2 may be disposed on the fifth insulating layer INS5. The second connection electrode CNE2 may be connected to the first connection electrode CNE1 through a second contact hole CH2 defined by the fourth insulating layer INS4 and the fifth insulating layer INS5.

A sixth insulating layer INS6 may be disposed on the second connection electrode CNE2. A layer from the buffer layer BFL and the sixth insulating layer INS6 may be defined as the circuit element layer DP-CL. The first insulating layer INS1 to the sixth insulating layer INS6 may be inorganic layers or organic layers.

The first electrode AE may be disposed on the sixth insulating layer INS6. The first electrode AE may be connected to the second connection electrode CNE2 through a third contact hole CH3 defined by the sixth insulating layer INS6. A pixel defining film PDL, in which an opening PX_OP for exposing a predetermined portion of the first electrode AE is defined, may be disposed on the first electrode AE and the sixth insulating layer INS6.

The hole control layer HCL may be disposed on the first electrode AE and the pixel defining film PDL. The hole control layer HCL may include a hole transport layer and a hole injection layer.

The light emitting layer EML may be disposed on the hole control layer HCL. The light emitting layer EML may be disposed in an area corresponding to the opening PX_OP. The light emitting layer EML may include an organic material and/or an inorganic material. The light emitting layer EML may generate a light having any one of red, green, and blue.

The electron control layer ECL may be disposed on the light emitting layer EML and the hole control layer HCL. The electron control layer ECL may include an electron transport layer and an electron injection layer. The hole control layer HCL and the electron control layer ECL may be commonly disposed in the light emitting area PA and the non-light emitting area NPA.

The second electrode CE may be disposed on the electron control layer ECL. The second electrode CE may be commonly disposed in the pixels PX. A layer, on which the light emitting element OLED is disposed, may be defined as the display element layer DP-OLED.

The thin film encapsulation layer TFE may be disposed on the second electrode CE and may cover the pixel PX. The thin film encapsulation layer TFE may include a first encapsulation layer EN1 disposed on the second electrode CE, a second encapsulation layer EN2 disposed on the first encapsulation layer EN1, and a third encapsulation layer EN3 disposed on the second encapsulation layer EN2.

The first encapsulation layer EN1 and the third encapsulation layer EN3 may include inorganic insulating layers and protect the pixel PX from, for example, moisture/oxygen. The second encapsulation layer EN2 may include an organic insulating layer and protect the pixel PX from, for example, foreign substances such as dust particles.

A first voltage may be applied to the first electrode AE through the transistor TR, and a second voltage having a level lower than that of the first voltage may be applied to the second electrode CE. Holes and electrons injected into the light emitting layer EML are coupled to each other to form excitons, and as the excitons transition to a ground state, the light emitting element OLED may emit a light.

The input sensing unit ISP may be disposed on the thin film encapsulation layer TFE. The input sensing unit ISP may be directly manufactured on an upper surface of the thin film encapsulation layer TFE.

A base layer BS may be disposed on the thin film encapsulation layer TFE. The base layer BS may include an inorganic insulating layer. At least one inorganic insulating layer as the base layer BS may be provided on the thin film encapsulation layer TFE.

The input sensing unit ISP may include a first conductive pattern CTL1 and a second conductive pattern CTL2 disposed on the first conductive pattern CTL1. The first conductive pattern CTL1 may be disposed on the base layer BS. An insulating layer TINS may be disposed on the base layer BS and may cover the first conductive pattern CTL1. The insulating layer TINS may include an inorganic insulating layer or an organic insulating layer. The second conductive pattern CTL2 may be disposed on the insulating layer TINS.

The first conductive pattern CTL1 and the second conductive pattern CTL2 may overlap the non-light emitting area NPA. According to embodiments, the first conductive pattern CTL1 and the second conductive pattern CTL2 may be disposed in the non-light emitting area NPA between the light emitting areas PA and have a mesh shape.

The first conductive pattern CTL1 and the second conductive pattern CTL2 may form sensors of the input sensing unit ISP described above. For example, the first conductive pattern CTL1 and the second conductive pattern CTL2 having a mesh shape may be separated from each other in a predetermined area to form the sensors. A portion of the second conductive pattern CTL2 may be connected to the first conductive pattern CTL1.

The reflection preventing layer RPL may be disposed on the second conductive pattern CTL2. The reflection preventing layer RPL may include a black matrix BM and a plurality of color filters CF. The black matrix BM may overlap the non-light emitting area NPA, and the color filters CF may overlap the light emitting areas PA.

The black matrix BM may be disposed on the insulating layer TINS and may cover the second conductive pattern CTL2. An opening B_OP overlapping the light emitting area PA and the opening PX_OP may be defined in the black matrix BM. The black matrix BM may absorb and block a light. A width of the opening B_OP may be greater than a width of the opening PX_OP.

The color filters CF may be disposed on the first insulating layer TINS and the black matrix BM. The color filters CF may be disposed in the openings B_OP, respectively. A planarization insulating layer PINS may be disposed on the color filters CF. The planarization insulating layer PINS may provide a flat upper surface.

When an external light traveling toward the display panel DP, it may be reflected by the display panel DP and perceived by a user as a mirror-like reflection. To mitigate this phenomenon, the reflection preventing layer RPL may include the plurality of color filters CF that display the same colors as those of the pixels PX of the display panel DP. The color filters CF may filter the external light beam into the same colors as those of the pixels PX. In this case, the visibility of the external light to the user may be reduced, and the mirror-like effect may be prevented or reduced.

However, the present disclosure is not limited thereto. For example, according to embodiments, the reflection preventing layer RPL may include a polarizing film, which may reduce reflectance of the external light. The polarizing film may be separately manufactured and attached to the input sensing unit ISP by an adhesive layer. The polarizing film may include a phase retarder and/or a polarizer.

FIG. 9A is a cross-sectional view along line II-II′ illustrated in FIG. 7. FIG. 9B is a view illustrating a state in which a bending area illustrated in FIG. 9A is bent.

FIG. 9A is a view illustrating a portion of a display unit DSP, a portion of a support plate PLT, and a portion of the window module WM.

For convenience of explanation, a further description of components and technical aspects previously described will be omitted or simplified.

Referring to FIG. 9A, the display device DD may include the display unit DSP, the window module WM disposed on the display unit DSP, and the support plate PLT disposed under the display unit DSP. The support plate PLT may support the display module DM. The window module WM may include a window WIN, a window protecting layer WP, a hard coating layer HC, a first adhesive layer AL1, and a second adhesive layer AL2.

The display unit DSP may include the electronic panel EP, an impact absorbing layer ISL, the panel protecting layer PPL, a barrier layer BRL, and third to sixth adhesive layers AL3 to AL6. The display module DM may further include the impact absorbing layer ISL, the third adhesive layer AL3, and the fourth adhesive layer AL4. The configurations of the electronic panel EP and the panel protecting layer PPL have been described above in detail with reference to FIG. 5, and thus, a further description thereof will be omitted.

The impact absorbing layer ISL may be disposed on the electronic panel EP. The impact absorbing layer ISL may protect the electronic panel EP by absorbing an external impact applied from an upper side of the display device DD toward the electronic panel EP. The impact absorbing layer ISL may be manufactured in the form of a stretched film.

The impact absorbing layer ISL may include a flexible plastic material. The flexible plastic material may be defined as a synthetic resin film. For example, the impact absorbing layer ISL may include a flexible plastic material such as polyimide (PI) or polyethylene terephthalate (PET).

The window WIN may be disposed on the impact absorbing layer ISL. The window WIN may protect the electronic panel EP from external scratches. The window WIN may have optically transparent properties. The window WIN may include glass. However, the present disclosure is not limited thereto. For example, according to embodiments the window WIN may include a synthetic resin film.

The window WIN may have a multi-layer structure or a single-layer structure. For example, the window WIN may include a plurality of synthetic resin films coupled with an adhesive or may include a glass substrate and a synthetic resin film coupled with an adhesive.

The window protecting layer WP may be disposed on the window WIN. The window protecting layer WP may include a flexible plastic material such as, for example, polyimide or polyethylene terephthalate. The hard coating layer HC may be disposed on an upper surface of the window protecting layer WP.

A printing layer PIT may be disposed on a lower surface of the window protecting layer WP. The printing layer PIT may have black color, but the color of the printing layer PIT is not limited thereto. The printing layer PIT may overlap an edge of the window WIN.

The barrier layer BRL may be disposed under the panel protecting layer PPL. The barrier layer BRL may increase a resistance against a compressive force caused by external pressing. Thus, the barrier layer BRL may serve to prevent deformation of the electronic panel EP. The barrier layer BRL may include a flexible plastic material such as, for example, polyimide or polyethylene terephthalate.

The barrier layer BRL may have a color that absorbs a light. For example, the barrier layer BRL may have a black color. In this case, when the display module DM is viewed from the upper side of the display module DM, components disposed under the barrier layer BRL may not be visually recognized by a user.

The first adhesive layer AL1 may be disposed between the window protecting layer WP and the window WIN. The window protecting layer WP and the window WIN may be bonded to each other by the first adhesive layer AL1. The first adhesive layer AL1 may cover a portion of the printing layer PIT.

The second adhesive layer AL2 may be disposed between the window WIN and the impact absorbing layer ISL. The window WIN and the impact absorbing layer ISL may be bonded to each other by the second adhesive layer AL2.

The third adhesive layer AL3 may be disposed between the impact absorbing layer ISL and the electronic panel EP. The impact absorbing layer ISL and the electronic panel EP may be bonded to each other by the third adhesive layer AL3.

The fourth adhesive layer AL4 may be disposed between the electronic panel EP and the panel protecting layer PPL. The electronic panel EP and the panel protecting layer PPL may be bonded to each other by the fourth adhesive layer AL4.

The fifth adhesive layer AL5 may be disposed between the panel protecting layer PPL and the barrier layer BRL. The panel protecting layer PPL and the barrier layer BRL may be bonded to each other by the fifth adhesive layer AL5.

The sixth adhesive layer AL6 may be disposed between the barrier layer BRL and the support plate PLT, which will be described in further detail below. For example, the support plate PLT may be disposed under the barrier layer BRL, and the sixth adhesive layer AL6 may be disposed between the barrier layer BRL and the support plate PLT. The barrier layer BRL and the support plate PLT may be bonded to each other by the sixth adhesive layer AL6.

According to embodiments, the sixth adhesive layer AL6 may overlap the first non-folding area NFA1 and the second non-folding area NFA2 and does not overlap the folding area FA. That is, according to an embodiment, the sixth adhesive layer AL6 is not disposed in the folding area FA.

The first to sixth adhesive layers AL1 to AL6 may include a transparent adhesive such as, for example, a pressure sensitive adhesive (PSA) or an optically clear adhesive (OCA), but the type of adhesive is not limited thereto.

A thickness of the first adhesive layer AL1 may be about the same as a thickness of the barrier layer BRL, and a thickness of each of the second adhesive layer AL2 and the third adhesive layer AL3 may be about the same as a thickness of the panel protecting layer PPL. A thickness of the fourth adhesive layer AL4 may be about the same as a thickness of the fifth adhesive layer AL5.

The thickness of each of the fourth adhesive layer AL4 and the fifth adhesive layer AL5 may be smaller than a thickness of the electronic panel EP and greater than a thickness of the impact absorbing layer ISL. A thickness of the sixth adhesive layer AL6 may be smaller than the thickness of the impact absorbing layer ISL. A thickness of the hard coating layer HC may be smaller than the thickness of the sixth adhesive layer AL6.

The electronic panel EP, the impact absorbing layer ISL, the panel protecting layer PPL, the third adhesive layer AL3, and the fourth adhesive layer AL4 may have about the same widths. The window protecting layer WP, the hard coating layer HC, and the first adhesive layer AL1 may have about the same widths.

The widths of the window protecting layer WP, the hard coating layer HC, and the first adhesive layer AL1 may be greater than the widths of the electronic panel EP, the impact absorbing layer ISL, the panel protecting layer PPL, the third adhesive layer AL3, and the fourth adhesive layer AL4. Edges of the window protecting layer WP, the hard coating layer HC, and the first adhesive layer AL1 may be disposed outside edges of the electronic panel EP, the impact absorbing layer ISL, the panel protecting layer PPL, the third adhesive layer AL3, and the fourth adhesive layer AL4.

A width of the window WIN in the first direction DR1 may be smaller than the widths of the electronic panel EP, the impact absorbing layer ISL, the panel protecting layer PPL, the third adhesive layer AL3, and the fourth adhesive layer AL4 in the first direction DR1. The edge of the window WIN may be disposed inside the edges of the electronic panel EP, the impact absorbing layer ISL, the panel protecting layer PPL, the third adhesive layer AL3, and the fourth adhesive layer AL4.

A width of the second adhesive layer AL2 in the first direction DR1 may be smaller than the width of the window WIN in the first direction DR1. An edge of the second adhesive layer AL2 may be disposed inside the edge of the window WIN.

The widths of the barrier layer BRL, the fifth adhesive layer AL5, and the sixth adhesive layer AL6 may be smaller than the width of the second adhesive layer AL2. Edges of the barrier layer BRL, the fifth adhesive layer AL5, and the sixth adhesive layer AL6 may be disposed inside an edge of the second adhesive layer AL2.

The support plate PLT may be disposed under the display unit DSP to support the display unit DSP. The support plate PLT may be disposed under the electronic panel EP and may support the electronic panel EP. The support plate PLT may have greater rigidity than that of the display unit DSP.

The support plate PLT may include a non-metallic material. For example, the support plate PLT may include a reinforced fiber composite. The reinforced fiber composite may be, for example, carbon fiber reinforced plastic (CFRP) or glass fiber reinforced plastic (GFRP).

The support plate PLT may include the reinforced fiber composite, and thus may be lightweight. The support plate PLT according to an embodiment may include the reinforced fiber composite, thus having a light weight compared to a metal support plate using a metal material, and have a modulus and a strength similar to that of the metal support plate.

Further, because the support plate PLT includes the reinforced fiber composite, a shape of the support plate PLT may be easily processed as compared to the metal support plate. For example, the support plate PLT including the reinforced fiber composite material may be more easily processed through a laser process or a microblast process.

However, this is illustrative, and the present disclosure is not limited thereto. For example, according to embodiments, the support plate PLT may include a metallic material.

The support plate PLT may include a first non-folding part PLT1, a folding part PLF, and a second non-folding part PLT2. The first non-folding part PLT1 may overlap the first non-folding area NFA1. The folding part PLF may overlap the folding area FA. The second non-folding part PLT2 may overlap the second non-folding area NFA2.

A plurality of openings OP may be defined in the folding part PLF. The openings OP may be formed to pass through portions of the support plate PLT in the third direction DR3. When viewed in the second direction DR2, the openings OP may be disposed to be spaced apart from each other in the first direction DR1. The openings OP may be formed through the above-described laser process or the above-described microblast process. A width of a portion, in which the openings OP are formed, in the first direction DR1, may be smaller than a width of a portion, in which the sixth adhesive layer AL6 is open, in the first direction DR1.

As the openings OP are defined in the portions of the support plate PLT overlapping the folding area FA, flexibility of the portions of the support plate PLT overlapping the folding area FA may increase. As a result, the support plate PLT may be folded about the folding area FA.

The folding part PLF may include branch parts BR. The branch parts BR may be disposed between the openings OP adjacent to each other in the first direction DR1.

According to embodiments, the display device DD may further include a digitizer, a shielding layer, and a heat dissipating layer disposed under the support plate PLT.

Referring to FIG. 9B, according to embodiments, the panel protecting layer PPL and the fourth adhesive layer AL4 are not disposed below the bending area BA. The panel protecting layer PPL and the fourth adhesive layer AL4 may be disposed on a lower surface of the second area AA2 facing a lower surface of the first area AA1 of the electronic panel EP. The data driver DDV may be disposed on an upper surface facing the lower surface of the second area AA2 of the electronic panel EP.

A printed circuit board PCB may be connected to the second area AA2 of the electronic panel EP. The printed circuit board PCB may be connected to one side of the second area AA2. The bending area BA may be bent so that the second area AA2 may be disposed under the first area AA1. Thus, the data driver DDV and the printed circuit board PCB may be disposed under the first area AA1.

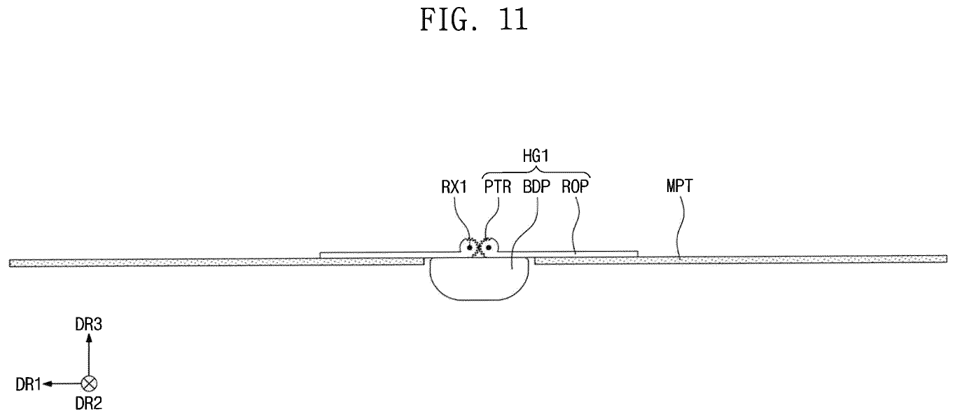

FIG. 10 is an exploded perspective view of a hinge module illustrated in FIG. 3. FIG. 11 is a view for describing main plates and first hinges illustrated in FIG. 10.

FIG. 11 is a view illustrating the first hinge HG1 and the main plates MPT when viewed in the second direction DR2.

For convenience of explanation, a further description of components and technical aspects previously described with reference to FIGS. 10 and 11 will be omitted or simplified.

Referring to FIG. 10, the hinge module EDC may include the housing assembly HS, the plurality of main plates MPT, the hinges HG1 and HG2, and the plurality of moving plates MVT.

The housing assembly HS may include the first housing HS1, the hinge housing HGH, and the second housing HS2 disposed in the first direction DR1. The hinge housing HGH may be disposed between the first housing HS1 and the second housing HS2. The first housing HS1 and the second housing HS2 may be disposed on both sides of the hinge housing HGH, which are opposite to each other in the first direction DR1.

The first housing HS1 and the second housing HS2 may extend longer in the second direction DR2 than in the first direction DR1. Widths of the first housing HS1 and the second housing HS2 in the first direction DR1 and the second direction DR2 may be about the same. According to embodiments, the first housing HS1 and the second housing HS2 may have a shape of a partial hexahedron. However, the shape of the first housing HS1 and the second housing HS2 are not limited thereto.

The first housing HS1 and the second housing HS2 may include a bottom part BP and sidewalls ISD. The sidewalls ISD may extend from edges of the bottom parts BP in the third direction DR3. The sidewalls ISD may include first sidewall portions ISD1 and second sidewall portions ISD2. The first sidewall portions ISD1 may extend in the first direction DR1. The first sidewall portions ISD1 may face each other in the second direction DR2. The second sidewall portions ISD2 may extend in the second direction DR2 and may be connected to both ends of the first sidewall portions ISD1. The second sidewall portions ISD2 may face the hinge housing HGH.

The first housing HS1 and the second housing HS2 may define accommodation grooves AGR. The accommodation grooves AGR may extend in the third direction DR3 from upper surfaces to lower surfaces of the first housing HS1 and the second housing HS2. The accommodation grooves AGR may be defined by inner surfaces of the sidewalls ISD and upper surfaces of the bottom parts BP of the first housing HS1 and the second housing HS2. The accommodation grooves AGR may accommodate the display device DD (see FIG. 9A), the main plates MPT, and the moving plates MVT. The upper surface of the bottom part BP may be defined as bottom surfaces of the accommodation grooves AGR.

Sliding grooves SGR may be defined by inner surfaces of the first sidewall portions ISD1. The sliding grooves SGR may be defined by inner surfaces of the first sidewall portions ISD1, which face each other. The sliding grooves SGR may extend in the first direction DR1.

The hinge housing HGH may extend in the second direction DR2. A width of the hinge housing HGH in the first direction DR1 may be smaller than a width of the first housing HS1 in the first direction DR1 and a width of the second housing HS2 in the first direction DR1. A width of the hinge housing HGH in the second direction DR2 may be about the same as a width of the first housing HS1 in the second direction DR2 and a width of the second housing HS2 in the second direction DR2.

The hinge housing HGH may include a rod portion BW and a plurality of sidewall portions SW. The rod portion BW may extend in the second direction DR2. The sidewall portions SW may be disposed on both sides of the rod portion BW, which are opposite to each other in the second direction DR2.

The hinge housing HGH may define a hinge groove HGR accommodating the hinges HG1 and HG2. The hinge groove HGR may be defined by the rod portion BW and the sidewall portions SW.

The hinges HG1 and HG2 may include a plurality of first hinges HG1 and the second hinge HG2. The first hinges HG1 may be disposed in the second direction DR2. That is, the first hinges HG1 may be spaced apart from each other in the second direction DR2. Although two first hinges HG1 are illustrated in FIG. 10, the number of first hinges HG1 is not limited thereto. Hereinafter, one of the two first hinges HG1 will be described.

Referring to FIGS. 10 and 11, the first hinge HG1 may include a body part BDP, a plurality of rotating parts ROP, a plurality of protrusions PTR, and a plurality of pins PN. The rotating parts ROP may be disposed on an upper surface of the body part BDP. The rotating parts ROP may be disposed in the first direction DR1. The openings OP may be defined in an area adjacent to one of both sides of the rotating parts ROP opposite to each other in the first direction DR1. When viewed in the second direction DR2, the openings OP may have a circular shape. The sides of the rotating parts ROP that are opposite each other in the first direction DR1 may be referred to as the sides facing each other.

The protrusions PTR may be disposed on one side of each of the two sides of the rotating parts ROP opposite to each other in the first direction DR1 disposed. The protrusions PTR may be disposed in a curved shape. The protrusions PTR facing each other in the first direction DR1 may be engaged with each other.

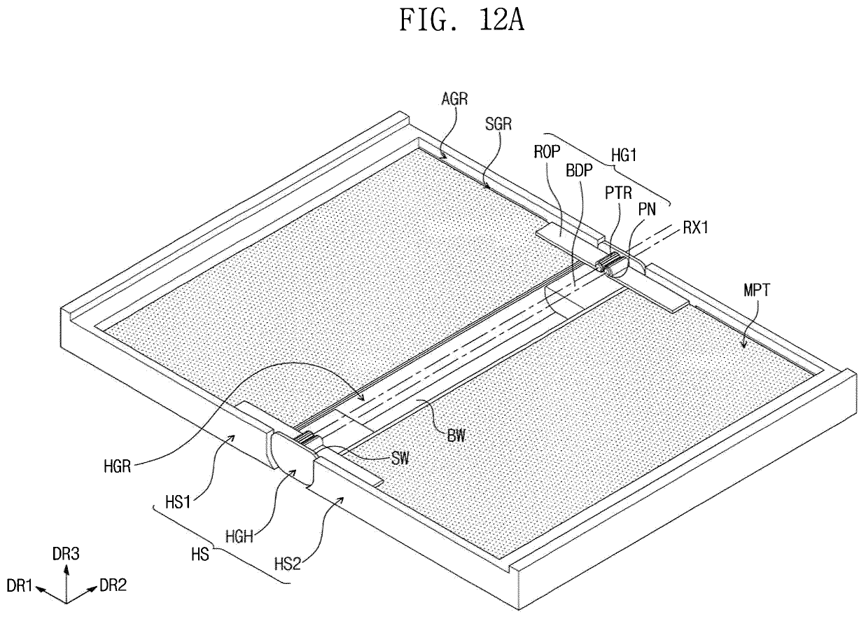

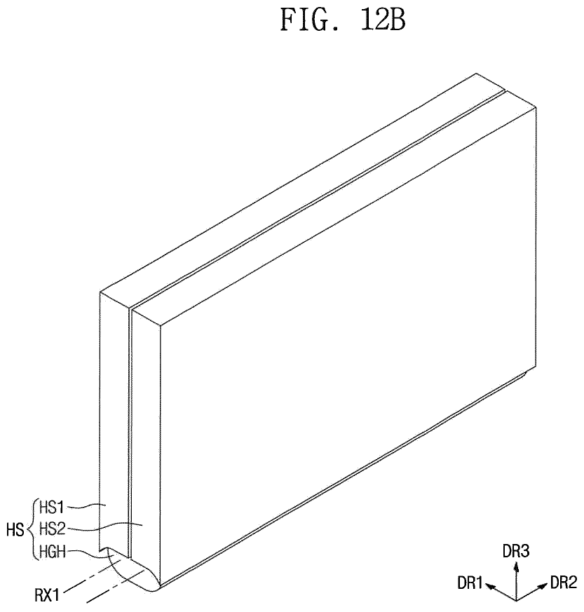

The pins PN may extend in the second direction DR2 (e.g., extend lengthwise in the second direction DR2) and may be disposed in the first direction DR1 (e.g., disposed adjacent to each other in the first direction DR1. Each of the pins PN may be inserted into a corresponding one of the openings OP to couple the first hinge HG1 to the housing assembly HS. This will be described in further detail with reference to FIG. 12A.

The first hinge HG1 may define a first rotating axis RX1 extending in the second direction DR2. As illustrated in FIG. 11, the main plates MPT, which will be described further below, may be coupled to the first hinge HG1 and rotate about the first rotating axis RX1. The rotation of the main plates MPT will be described in further detail below.

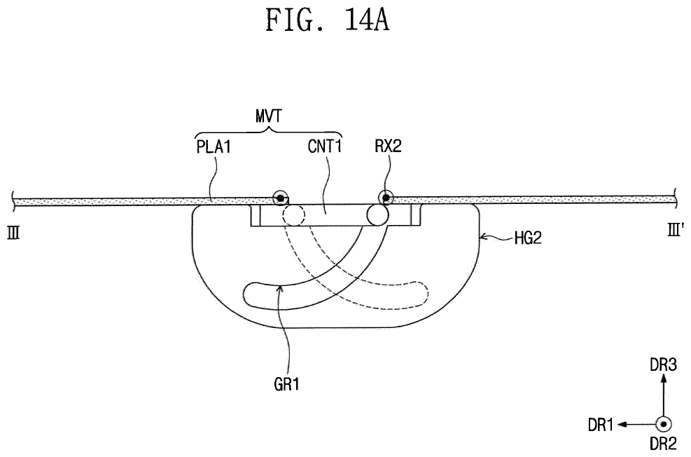

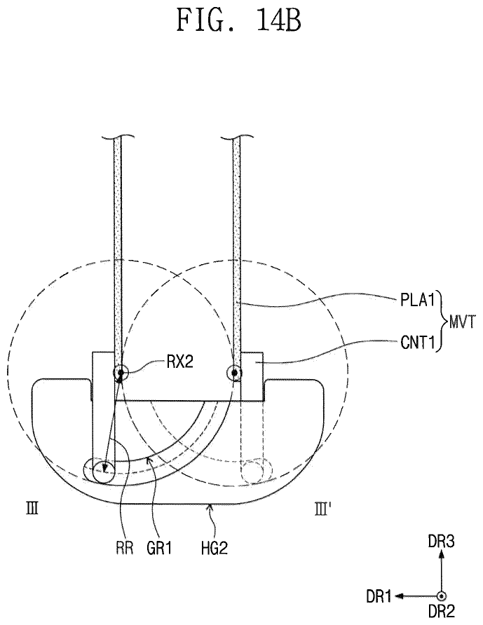

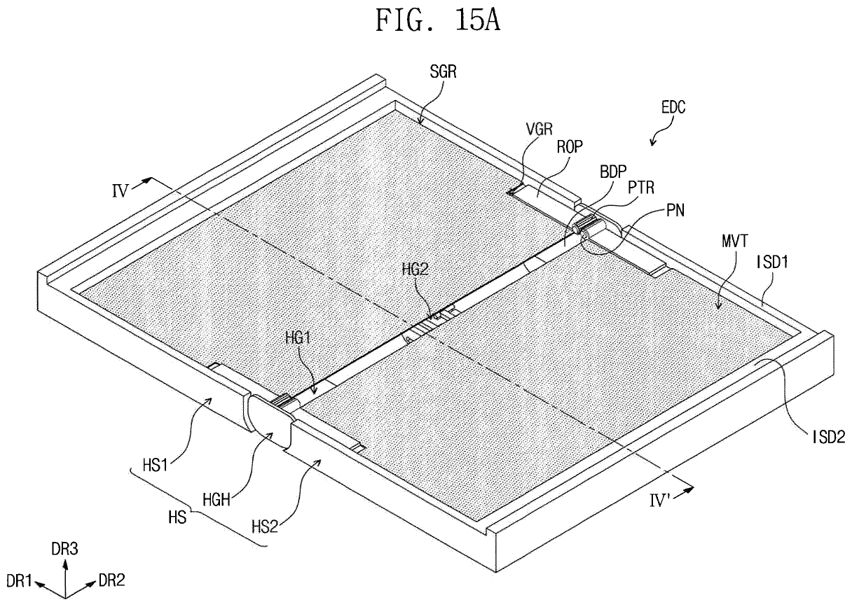

The second hinge HG2 may be disposed between the first hinges HG1 in the second direction DR2. First grooves GR1 may be defined in the second hinge HG2. The first grooves GR1 may have a curved shape. The first grooves GR1 may be disposed in the second direction DR2. As illustrated in FIG. 14A, the first grooves GR1 may be symmetrical to each other in the second direction DR2. A second rotating axis RX2 (see FIG. 14A) may be defined by the first grooves GR1. The second rotating axis RX2 (see FIG. 14A) will be described in further detail with reference to FIGS. 14A and 14B.

Referring to FIGS. 10 and 11, the main plates MPT may be disposed in the first direction DR1. That is, the main plates MPT may be spaced apart from each other in the first direction DR1. The main plates MPT may be parallel to the plane defined by the first direction DR1 and the second direction DR2.

As illustrated in FIG. 11, the main plates MPT may be disposed on both sides of the first hinges HG1 opposite to each other in the first direction DR1. The main plates MPT may be coupled to the rotating parts ROP. For example, one main plate MPT may be coupled to one rotating part ROP, and another main plate MPT may be coupled to another rotating part ROP. The rotating parts ROP may be disposed on upper surfaces of the main plates MPT.

As the main plates MPT are coupled to the first hinges HG1, when the rotating parts ROP rotate about the first rotating axis RX1, the main plates MPT may rotate about the first rotating axis RX1.

FIGS. 12A and 12B are views for describing coupling between the main plates, the first hinges, and a housing assembly.

FIG. 12A illustrates the housing assembly HS and the main plates MPT in an unfolded state, and FIG. 12B illustrates the housing assembly HS in a folded state.

For convenience of explanation, a further description of components and technical aspects previously described with reference to FIGS. 12A and 12B will be omitted or simplified.

Referring to FIGS. 10, 11, and 12A, the first hinge HG1 and the main plates MPT in a coupled state may be coupled to the housing assembly HS. The first hinge HG1 may be disposed in the hinge groove HGR defined in the hinge housing HGH. The first hinge HG1 may be disposed adjacent to both sides of the hinge housing HGH opposite to each other in the second direction DR2.

Each of the pins PN may be coupled to the sidewall portions SW through a corresponding one of the openings OP. The rotating parts ROP and the body parts BDP coupled to the rotating parts ROP may be fixed to the hinge housing HGH by the pins PN.

The main plates MPT may be disposed in the accommodation grooves AGR defined in the first housing HS1 and the second housing HS2. The main plates MPT may be disposed on bottom surfaces. Lower surfaces and bottom surfaces of the main plates MPT may be connected to each other by an adhesive member. However, the present disclosure is not limited thereto. For example, according to embodiments, the main plates MPT, the first housing HS1, and the second housing HS2 may be integrally formed. The first housing HS1 and the second housing HS2 may be connected to the first hinges HG1 by the main plates MPT.

Referring to FIGS. 12A and 12B, when the main plates MPT rotate about the first rotating axis RX1, the first housing HS1 and the second housing HS2 connected to the main plates MPT may rotate about the first rotating axis RX1. The first housing HS1 and the second housing HS2 may rotate to face each other in the first direction DR1.

Referring to FIG. 10, the moving plates MVT may be disposed in the first direction DR1. For example, the moving plates MVT may be spaced apart from each other in the first direction DR1. The moving plates MVT may be parallel to the plane defined by the first direction DR1 and the second direction DR2.

The moving plates MVT may include first planarization parts PLA1 and first connection parts CNT1. The first planarization parts PLA1 may be parallel to the plane defined by the first direction DR1 and the second direction DR2. The first planarization parts PLA1 may be disposed in the first direction DR1. For example, the first planarization parts PLA1 may be disposed adjacent to each other in the first direction DR1.

Both sides of the first planarization parts PLA1, which are opposite to each other in the second direction DR2, may be recessed. Avoidance grooves VGR are formed on these recessed sides of the first planarization parts PLA1. These avoidance grooves VGR may extend from one side of the first planarization parts PLA1 (opposite to each other in the first direction DR1) toward the other side in the same direction. The sides of the first planarization parts PLA1 that face each other in the first direction DR1 may be referred to as the facing sides. The avoidance grooves VGR may have a shape corresponding to a portion of a quadrangular shape.

The first connection parts CNT1 may be disposed on one side of each of the two opposing sides of the first planarization parts PLA1 in the first direction DR1. As illustrated in FIG. 14A, which will be described below, the first connection parts CNT1 may be disposed on lower surfaces of the first planarization parts PLA1.

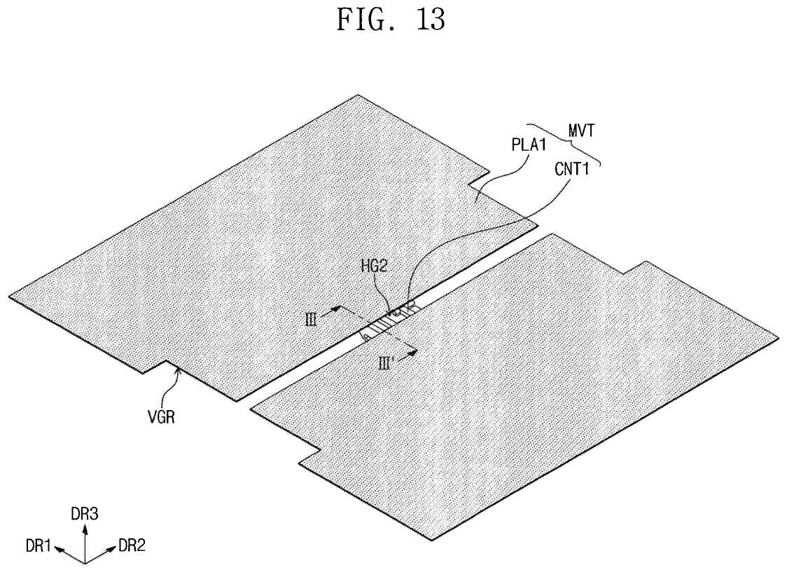

FIG. 13 is a view for describing coupling between moving plates and a second hinge. FIGS. 14A and 14B are cross-sectional views of the moving plates and the second hinge corresponding to line III-III′ illustrated in FIG. 13.

FIG. 14A is a view illustrating the moving plates in an unfolded state, and FIG. 14B is a view illustrating the moving plates in a folded state.

For convenience of explanation, a further description of components and technical aspects previously described with reference to FIGS. 13, 14A, and 14B will be omitted or simplified.

Referring to FIGS. 13, 14A, and 14B, the moving plates MVT may be coupled to the second hinge HG2 defining the second rotating axis RX2. When the electronic device ED (see FIG. 1) is folded, the first connection parts CNT1 may rotate about the second rotating axis RX2. The first planarization parts PLA1 connected to the first connection parts CNT1 may rotate about the second rotating axis RX2.

For example, each of the first connection parts CNT1 may be disposed adjacent to a corresponding one of the first grooves GR1. When the electronic device ED (see FIG. 1) is folded, one side of each first connection part CNT1 can move along the corresponding first groove GR1, conforming to the groove's shape. Each of the first connection parts CNT1 may move by a predetermined arc having a predetermined radius RR of curvature from the second rotating axis RX2 with respect to the second rotating axis RX2. When the first connection parts CNT1 move, the first planarization parts PLA1 connected to the first connection parts CNT1 may move. The radius RR of curvature may be a linear distance from the second rotating axis RX2 to an imaginary line disposed between inner surfaces defining the first grooves GR1 on a side surface thereof.

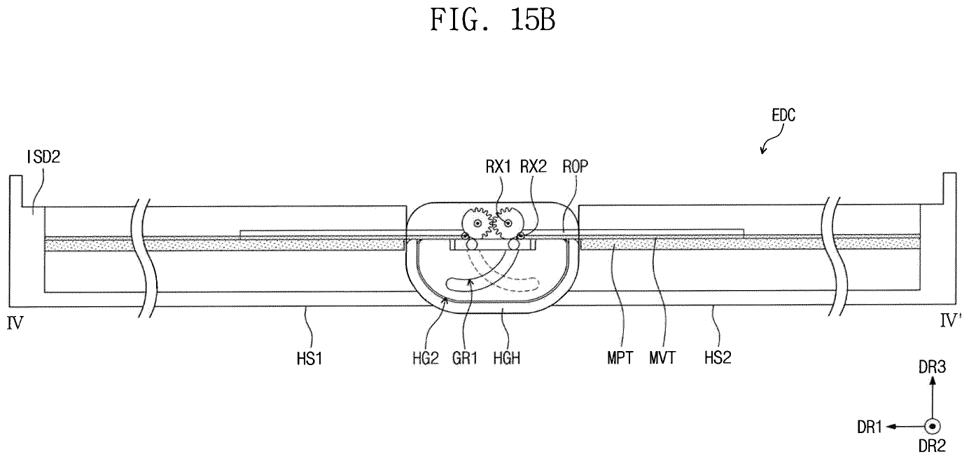

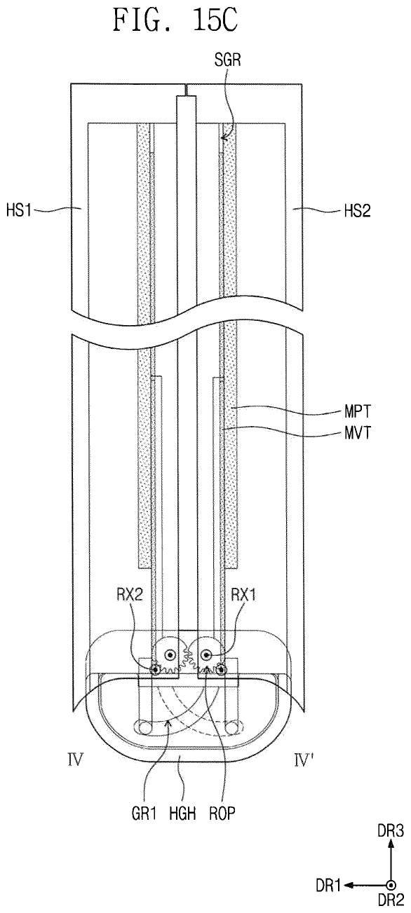

FIG. 15A is a perspective view of the second hinge and the moving plates coupled to the housing assembly. FIGS. 15B and 15C are cross-sectional views of the hinge module corresponding to line IV-IV′ illustrated in FIG. 15A.

FIG. 15B is a view illustrating the hinge module EDC in an unfolded state. FIG. 15C is a view illustrating the hinge module EDC in a folding state.

For convenience of explanation, a further description of components and technical aspects previously described with reference to FIGS. 15A and 15C will be omitted or simplified.

Referring to FIGS. 10 and 15A, the second hinge HG2 and the moving plates MVT may be coupled to the housing assembly HS. The second hinge HG2 may be disposed in the hinge groove HGR defined in the hinge housing HGH. The second hinge HG2 may be disposed between the first hinges HG1 inside the hinge groove HGR.

The moving plates MVT may be disposed inside the accommodation grooves AGR defined by the first housing HS1 and the second housing HS2. The moving plates MVT may be disposed on the main plates MPT.

Both sides of the moving plates opposite to each other in the second direction DR2 may be disposed on the sliding grooves SGR defined in the inner surfaces of the first sidewall portions ISD1. The moving plates MVT may be inserted into the sliding grooves SGR and slide in the first direction DR1.

When the moving plates MVT are inserted into the sliding grooves SGR, the rotating parts ROP may be disposed inside the avoidance grooves VGR. A length of the avoidance grooves VGR in the first direction DR1 may be greater than a length of the rotating parts ROP in the first direction DR1. The rotating parts ROP may reciprocate in the avoidance grooves VGR in the first direction DR1.

Referring to FIG. 15B, in an unfolded state, the other sides of both sides of the moving plates MVT opposite to each other in the first direction DR1 may overlap one sides of both sides of the main plates MPT opposite to each other in the first direction DR1. The other sides of the moving plates MVT and the one sides of the main plates MPT may be aligned in the third direction DR3.

For example, referring to FIG. 15B, in an embodiment, in an unfolded state, the opposite sides of the moving plates MVT in the first direction DR1 may overlap with one side of the main plates MPT in the same direction. Additionally, The overlapping sides of the moving plates MVT and the main plates MPT may be aligned in the third direction DR3.

Referring to FIGS. 15B and 15C, the first rotating axis RX1 may be arranged above the second rotating axis RX2. A height of the first rotating axis RX1 may be greater than a height of the second rotating axis RX2. For example, referring to FIGS. 15B and 15C, in an embodiment, the first rotating axis RX1 may be disposed above the second rotating axis RX2. A height of the first rotating axis RX1, relative to the bottom parts of the first housing HS1 and the second housing HS2, may be greater than a height of the second rotating axis RX2. For example, among the first rotating axis RX1 and the second rotating axis RX2, the first rotating axis RX1 is disposed closer to the display device DD (see also FIG. 3). That is, a distance between the first rotating axis RX1 and the display device DD is less than a distance between the second rotating axis RX2 and the display device DD. For example, the first rotating axis RX1 is disposed between the second rotating axis RX2 and the display device DD

Accordingly, in the folded state, a distance between the one sides of the main plates MPT and the other sides of the moving plates MVT may increase. For example, according to embodiments, the one sides of the main plates MPT do not overlap the other sides of the moving plates MVT. The one sides of the main plates MPT may be disposed on the other sides of the moving plates MVT. The moving plates MVT may move downward along the sliding grooves SGR. For example, according to embodiments, as a result of the moving plates MVT moving downward along the sliding grooves SGR, when transitioning from being unfolded to folded, portions of the one sides of the main plates MPT and the other sides of the moving plates MVT, which overlapped and contacted each other in the unfolded state (see FIG. 15B), do not overlap and do not contact each other in the folded state (see FIG. 15C). For example, while portions of the one sides of the main plates MPT and the other sides of the moving plates MVT make contact (e.g., direct contact) with each other in the unfolded state (see FIG. 15B), the same portions of these sides do not make contact (e.g., direct contact) in the folded state (see FIG. 15C) due to the moving plates MVT moving downward along the sliding grooves SGR.

When the hinge module EDC is folded, a distance between the second sidewall portions ISD2 and the other sides of the moving plates MVT may increase. In the folded state, a distance between the second sidewall portions ISD2 and the other sides of the moving plates MVT may be greater than a distance between the second sidewall portions ISD2 and the one sides of the main plates MPT.

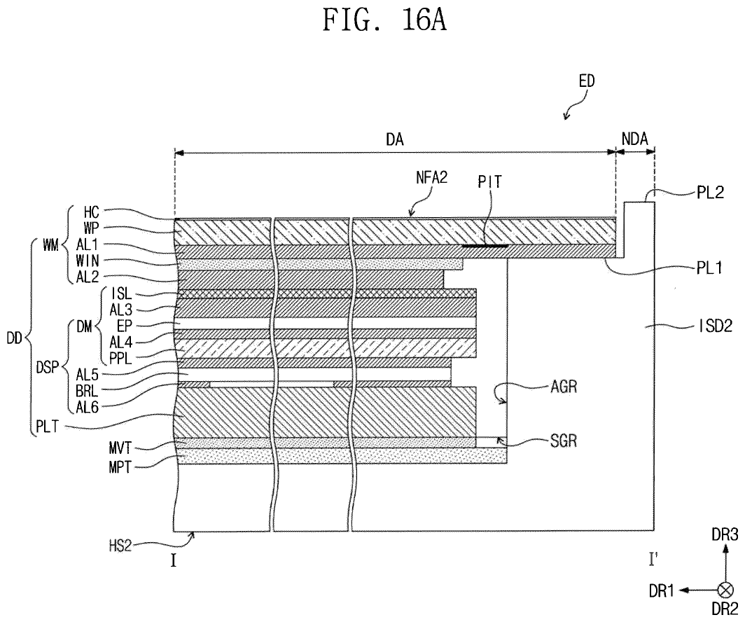

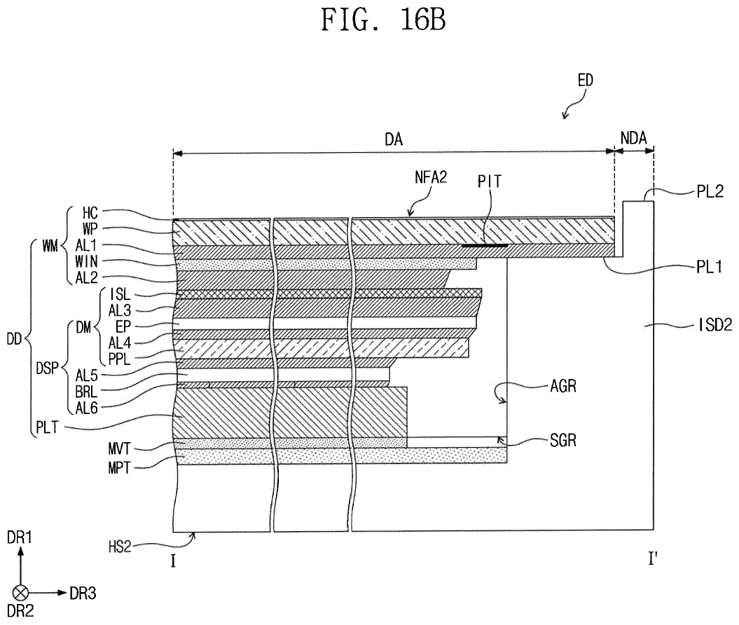

FIGS. 16A and 16B are cross-sectional views of the electronic device corresponding to line I-I′ illustrated in FIG. 1.

FIG. 16A is a view illustrating the electronic device ED in an unfolded state. FIG. 16B is a view illustrating the electronic device ED in a folded state.

For convenience of description, in FIG. 16B, the electronic device ED is illustrated while rotated by about 90 degrees in a clockwise direction.

For convenience of explanation, a further description of components and technical aspects previously described with reference to FIGS. 16A and 16B will be omitted or simplified.

Referring to FIG. 16A, upper surfaces PL1 and PL2 of the second sidewall portions ISD2 may have steps, e.g., may be formed in a step formation. The upper surfaces of the second sidewall portions ISD2 may include the first surface PL1 and the second surface PL2. A height of the first surface PL1 may be smaller than a height of the second surface PL2. The second surface PL2 may be disposed on the first surface PL1.

The display device DD may be disposed in the accommodation groove AGR. The support plate PLT may be disposed on an upper surface of the moving plate MVT. An adhesive member may be disposed between a lower surface of the support plate PLT and the upper surface of the moving plate MVT.

The window module WM may be disposed on the upper surfaces PL1 and PL2 of the second sidewall portions ISD2. The window module WM may be disposed on the first surface PL1. The window protecting layer WP, the hard coating layer HC, and the first adhesive layer AL1 may be disposed on the first surface PL1. The hard coating layer HC and the window protecting layer WP may be fixed to the first surface PL1 by the first adhesive layer AL1.

The window protecting layer WP may be disposed on the first surface PL1 and may cover the accommodation groove AGR between the display device DD and the second sidewall portions ISD2. Accordingly, the window protecting layer WP may prevent foreign substances or moisture from being introduced into the accommodation groove AGR. Further, to cover the accommodation groove AGR, the second sidewall portions ISD2 may be prevented from extending to the upper side of the display device DD, and thus, an area of the display area DA (see FIG. 1) may increase.

Referring to FIGS. 15C, 16A, and 16B, when the electronic device ED is folded, a slip phenomenon may occur in the display device DD. Due to the slip phenomenon, a distance between an edge of the window module WM and an edge of the support plate PLT may be increased.

The second housing HS2 may rotate about the first rotating axis RX1 to correspond to the amount of slips generated in the window module WM. Accordingly, the first adhesive layer AL1, the window protecting layer WP, and the hard coating layer HC of the window module WM may be fixed to the second housing HS2. The first adhesive layer AL1, the window protecting layer WP, and the hard coating layer HC may be fixed onto the first surface PL1. Thus, the first adhesive layer AL1, the window protecting layer WP, and the hard coating layer HC may stably cover the accommodation groove AGR, and as a result, slips of the display device DD may be prevented from being visually recognized by a user.

When the electronic device ED is folded, the moving plate MVT may rotate about the second rotating axis RX2. While rotating, the moving plate MVT may move along the sliding groove SGR to correspond to the amount of slips generated in the support plate PLT. Accordingly, in embodiments, the moving plate MVT and the support plate PLT are not separated from each other. Thus, occurrence of defects in the electronic device ED may be prevented during folding, and thus, folding reliability of the electronic device ED may be improved.

For example, referring to FIGS. 15C, 16A, and 16B, folding the electronic device ED can result in a slip phenomenon in the display device DD, where the distance between the edge of the window module WM and the edge of the support plate PLT increases. To address this, in embodiments of the present application, the second housing HS2 may rotate around the first rotating axis RX1, which may compensate for the slip in the window module WM. As a result, the first adhesive layer AL1, the window protecting layer WP, and the hard coating layer HC of the window module WM may remain securely attached to the second housing HS2 and fixed onto the first surface PL1. By maintaining this stable attachment, the first adhesive layer AL1, the window protecting layer WP, and the hard coating layer HC may effectively cover the accommodation groove AGR, which may prevent the slip of the display device DD from being visible to the user.

Additionally, as the electronic device ED folds, the moving plate MVT may rotate around the second rotating axis RX2 and shift along the sliding groove SGR to adjust for the slip occurring in the support plate PLT. As a result of this movement, the moving plate MVT and the support plate PLT may remain connected, preventing separation. As a result, embodiments may reduce the risk of defects during folding and improve the folding reliability of the electronic device ED.

FIGS. 16A and 16B illustrate a portion of the display device DD, the second housing HS2, and the moving plate MVT and the main plate MPT disposed in the accommodation groove AGR of the second housing HS2. However, the other portion of the display device DD, the first housing HS1, and the moving plate MVT and the main plate MPT disposed in the accommodation groove AGR of the first housing HS1 may also have substantially the same configurations.

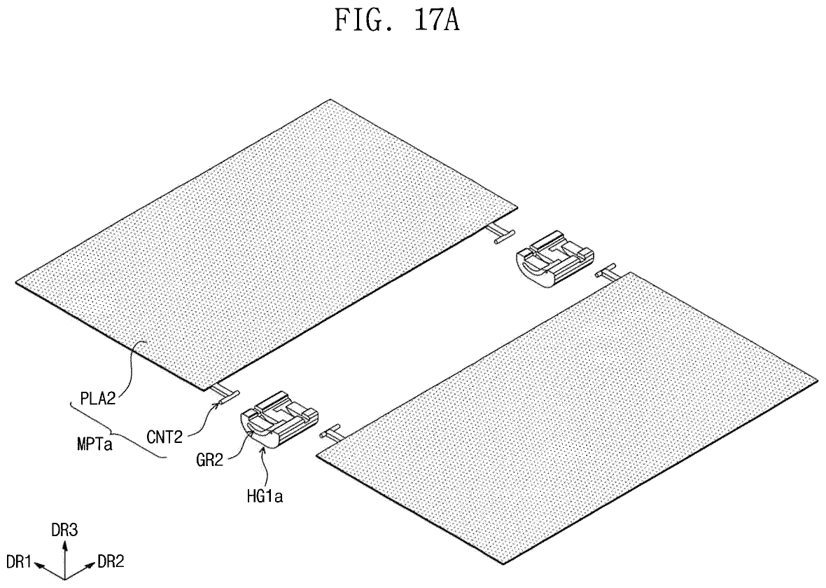

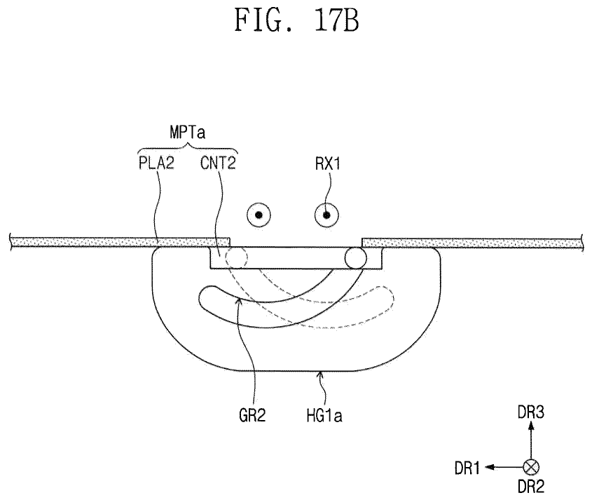

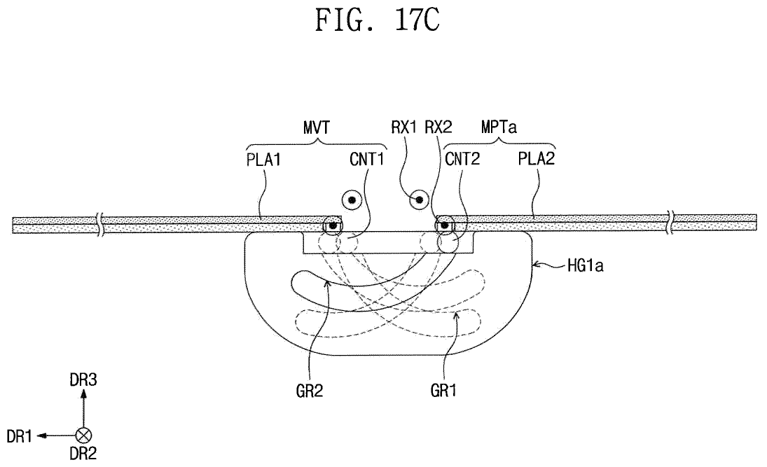

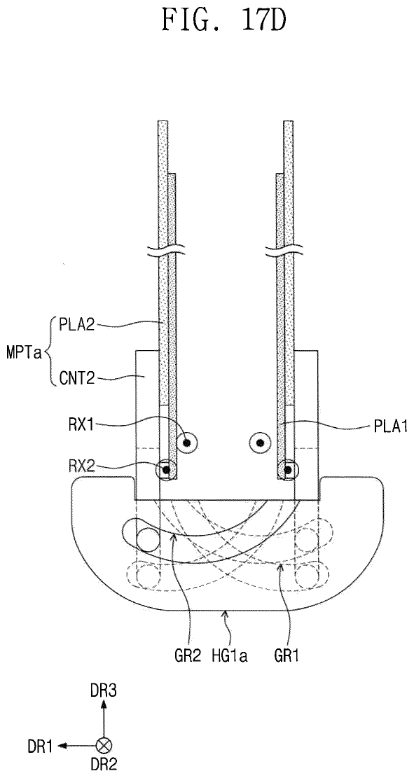

FIGS. 17A and 17B are views for describing the first hinges according to an embodiment of the present disclosure. FIGS. 17C and 17D are views for describing the first rotating axis and the second rotating axis.

FIG. 17A is an exploded perspective view of first hinges HG1a and main plates MPTa, and FIG. 17B is a side view of a coupled state of the first hinges HG1a and the main plates MPTa when viewed in the second direction DR2. FIG. 17C is a side view illustrating the main plates MPTa and the moving plates MVT in an unfolded state, and FIG. 17D is a side view illustrating the main plates MPTa and the moving plates MVT in a folded state.

In FIGS. 17C and 17D, the first grooves GR1 are illustrated by dotted lines.

For convenience of explanation, a further description of components and technical aspects previously described with reference to FIGS. 17A to 17D will be omitted or simplified.

Referring to FIGS. 17A and 17B, the first hinges HG1a may be disposed in the second direction DR2. Second grooves GR2 may be defined in the first hinges HG1a. The second grooves GR2 may have a curved shape. The second grooves GR2 defined in one of the first hinges HG1a may be symmetrical to each other in the second direction DR2.

The main plates MPTa may be disposed in the first direction DR1. The main plates MPTa may include second planarization parts PLA2 and second connection parts CNT2. The second planarization parts PLA2 may be parallel to the plane defined by the first direction DR1 and the second direction DR2.

The second connection parts CNT2 may be disposed on lower surfaces of the second planarization parts PLA2. The second connection parts CNT2 may be arranged on one sides, facing each other, of both sides of the second planarization parts PLA2 opposite to each other in the first direction DR1. In an embodiment, the second connection parts CNT2 may be disposed on the inward-facing sides of the opposing edges of the second planarization parts PLA2 along the first direction DR1. The pair of second connection parts CNT2 disposed on the lower surface of the one second planarization part PLA2 may be spaced apart from each other in the second direction DR2.

The main plates MPTa may be coupled to the first hinges HG1a. The second connection parts CNT2 may be disposed adjacent to the second grooves GR2. The second planarization parts PLA2 may be disposed on the first hinges HG1a.

Referring to FIGS. 17C and 17D, the main plates MPTa may rotate about the first rotating axis RX1 defined by the first hinges HG1a. When the electronic device ED (see FIG. 1) is folded, the second connection parts CNT2 may move along the second grooves GR2. When the second connection parts CNT2 rotate about the first rotating axis RX1, the second planarization parts PLA2 connected to the second connection parts CNT2 may rotate about the first rotating axis RX1.

In an unfolded state, the other sides of both sides of the main plates MPTa opposite to each other in the first direction DR1 and the other sides of both sides of the moving plates MVT opposite to each other in the first direction DR1 may overlap each other. The other sides of both sides of the main plates MPTa opposite to each other in the first direction DR1 and the other sides of both sides of the moving plates MVT opposite to each other in the first direction DR1 may be aligned in the third direction DR3.

In a folded state, in an embodiment, the other sides of both sides of the main plates MPTa opposite to each other in the first direction DR1 and the other sides of both sides of the moving plates MVT opposite to each other in the first direction DR1 do not overlap each other. The other sides of both sides of the main plates MPTa opposite to each other in the first direction DR1 may be disposed above the other sides of both sides of the moving plates MVT opposite to each other in the first direction DR1. A distance between the other sides of both sides of the main plates MPTa opposite to each other in the first direction DR1 and the other sides of both sides of the moving plates MVT opposite to each other in the first direction DR1 may increase.

For example, in an embodiment, in an unfolded state, opposing sides of the main plates MPTa and the opposing sides of the moving plates MVT, both oriented along the first direction DR1, may overlap each other. In addition, these overlapping sides of the main plates MPTa and the moving plates MVT may be aligned along the third direction DR3.

In a folded state, the opposing sides of the main plates MPTa and the moving plates MVT, oriented along the first direction DR1, no longer overlap. Instead, the sides of the main plates MPTa may be positioned above the corresponding sides of the moving plates MVT disposed. As a result, a distance between these opposing sides of the main plates MPTa and the moving plates MVT increases.

Referring to FIGS. 16A and 16B, a principle in which the moving plates MVT and the main plates MPTa compensate for the occurrence of slips generated in the display device DD has been described, and this may be applied in the same manner as in FIGS. 17C and 17D.

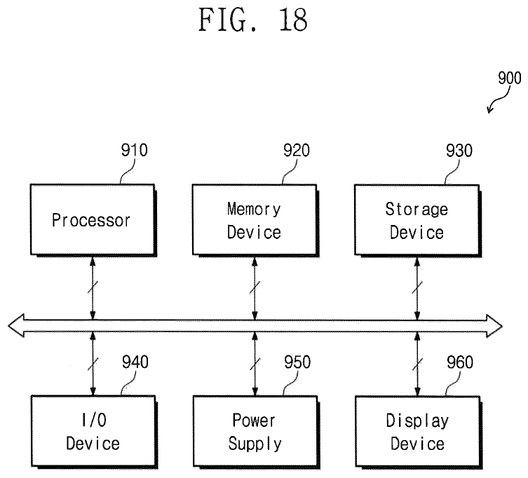

FIG. 18 is a block diagram illustrating an electronic device according to an embodiment.

Referring to FIG. 18, in an embodiment, an electronic device 900 may include a processor 910, a memory device 920, a storage device 930, an input/output (“I/O”) device 940, a power supply 950, and a display device 960. Here, the display device 960 may correspond to the display device described with reference to FIGS. 1 to 17D. The electronic device 900 may also include the hinge module EDC described with reference to FIGS. 1 to 17D. The electronic device 900 may further include a plurality of ports for communicating with a video card, a sound card, a memory card, a universal serial bus (“USB”) device, or the like. In an embodiment, the electronic device 900 may be implemented as a smartphone. However, embodiments are not limited thereto.

The processor 910 may perform various computing functions. In an embodiment, the processor 910 may be, for example, a microprocessor, a central processing unit (“CPU”), an application processor (“AP”), or the like. The processor 910 may be coupled to other components via, for example, an address bus, a control bus, a data bus, or the like. In an embodiment, the processor 910 may be coupled to an extended bus such as a peripheral component interconnection (“PCI”) bus.

The memory device 920 may store data for operations of the electronic device 900. In an embodiment, the memory device 920 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like, and/or at least one volatile memory device such as a dynamic random access memory (“DRAM”) device, a static random access memory (“SRAM”) device, a mobile DRAM device, or the like.

In an embodiment, the storage device 930 may include a solid state drive (“SSD”) device, a hard disk drive (“HDD”) device, a CD-ROM device, or the like. In an embodiment, the I/O device 940 may include an input device such as a keyboard, a keypad, a mouse device, a touchpad, a touch-screen, or the like, and an output device such as a printer, a speaker, or the like.

The power supply 950 may provide power for operations of the electronic device 900. The power supply 950 may provide power to the display device 960. The display device 960 may be coupled to other components via the buses or other communication links. In an embodiment, the display device 960 may be included in the I/O device 940.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

According to an embodiment of the present disclosure, a window protecting layer may be coupled to a housing, which may address a slip generated in a display module. Accordingly, it is possible to prevent the housing from covering an edge of the display module. Thus, an area of a display surface may be increased.

According to an embodiment of the present disclosure, when a housing rotates about a first rotating axis, a moving plate may rotate about a second rotating axis disposed below the first rotating axis and slide with respect to the housing. Accordingly, when a slip phenomenon occurs in a display module, the moving plate connected to a lower portion of the display module and the housing connected to an upper portion of the display module may compensate for the amount of slip generated in the display module. Thus, folding reliability of a display device may be improved.

While the present disclosure has been particularly shown and described with reference to embodiments thereof, it will be understood by those of ordinary skill in the art that various changes in form and detail may be made therein without departing from the spirit and scope of the present invention as defined by the following claims.

What is claimed is:

1. An electronic device, comprising:
a display device configured to be folded or unfolded with respect to a folding axis extending in a second direction; and
a hinge mechanism in which a plurality of accommodation grooves configured to accommodate the display device are defined,
wherein the hinge mechanism includes:
a plurality of housings defining the accommodation grooves and disposed in a first direction intersecting the second direction;
a first hinge disposed between the housings and defining a first rotating axis extending in the second direction;
a second hinge disposed between the housings and defining a second rotating axis extending in the second direction;
a plurality of main plates disposed inside the accommodation grooves, coupled to the first hinge, and configured to rotate about the first rotating axis; and
a plurality of moving plates disposed on the main plates inside the accommodation grooves, coupled to the second hinge, and configured to rotate about the second rotating axis, and
wherein among the first rotating axis and the second rotating axis, the first rotating axis is disposed at a greater height than the second rotating axis.

2. The electronic device of claim 1, wherein a distance between one side of each of the main plates opposite to each other in the first direction and one side of each of the moving plates opposite to each other in the first direction in a folded state is greater than a distance between the one side of each of the main plates and the one side of each of the moving plates in an unfolded state, and
wherein the one side of each of the main plates is a side spaced apart from the first hinge, and the one side of each of the moving plates is a side spaced apart from the second hinge.

3. The electronic device of claim 2, wherein, in the folded state, a height of edges of the main plates is greater than a height of edges of the moving plates.

4. The electronic device of claim 2, wherein the housings include:
a plurality of bottom parts;
a plurality of first sidewall portions disposed on both sides of the bottom parts opposite to each other in the second direction and extending in the first direction; and
a plurality of second sidewall portions disposed on one side of each of the bottom parts opposite to each other in the first direction and extending in the second direction, the one side being space apart from the first hinge,
wherein the main plates are fixedly coupled to the bottom parts, and
wherein the moving plates are disposed in sliding grooves defined on inner surfaces facing each other of the first sidewall portions and extending in the first direction, and slide in the first direction.

5. The electronic device of claim 4, wherein a distance between the one side of each of the main plates and the second sidewall portions in the folded state is about equal to a distance between the one side of each of the main plates and the second sidewall portions in the unfolded state, and
wherein a distance between the one side of each of the moving plates and the second sidewall portions in the folded state is greater than a distance between the one side of each of the moving plates and the second sidewall portions in the unfolded state.

6. The electronic device of claim 4, wherein the display device further includes:
a display panel;
a window disposed on the display panel; and
a support plate disposed under the display panel, and
wherein both sides of the window opposite to each other in the first direction are disposed outside an edge of the display panel and an edge of the support plate.

7. The electronic device of claim 6, wherein upper surfaces of the second sidewall portions include:
a plurality of first surfaces; and
a plurality of second surfaces disposed on the first surfaces, and
wherein both sides of the window opposite to each other in the first direction are disposed on the first surfaces, and
wherein the support plate is disposed on upper surfaces of the moving plates.

8. The electronic device of claim 1, wherein the moving plates include:
a plurality of first planarization parts having a plane defined by the second direction and the first direction; and
a plurality of first connection parts disposed adjacent to sides of the first planarization parts opposite to each other in the first direction, and
wherein the first connection parts are disposed in first grooves defined in the second hinge, and
wherein the first grooves have a curved shape, and
wherein the first grooves are disposed in the second direction and symmetrical to each other in the second direction.

9. The electronic device of claim 1, wherein the first hinge includes:
a body part; and
a plurality of rotating parts symmetrical to each other in the first direction on the body part and configured to rotate about the first rotating axis, and
wherein the rotating parts are coupled to upper surfaces of the main plates.

10. The electronic device of claim 1, wherein the main plates include:
a plurality of planarization parts having a plane defined by the second direction and the first direction; and
a plurality of connection parts disposed adjacent to sides of the planarization parts opposite to each other in the first direction, and
wherein the connection parts are disposed in second grooves defined in the first hinge, and
wherein the second grooves have a curved shape, and
wherein the second grooves are disposed in the second direction and symmetrical to each other in the second direction.

11. An electronic device, comprising:
a display device including a folding area configured to be folded or unfolded with respect to a folding axis extending in a second direction, and a plurality of non-folding areas disposed on both sides of the folding area opposite to each other in a first direction intersecting the second direction; and
a hinge mechanism disposed below the display device,
wherein the hinge mechanism includes:
a first hinge overlapping the folding area and defining a first rotating axis extending in the second direction;
a second hinge overlapping the folding area and defining a second rotating axis extending in the second direction below the first rotating axis;
a plurality of housings defining a plurality of accommodation grooves configured to accommodate the display device and connected to the first hinge such that the housings rotate about the first rotating axis; and
a plurality of moving plates disposed between the display device and the housings and connected to the second hinge such that the moving plates rotate about the second rotating axis.

12. The electronic device of claim 11, wherein the housings include:
a plurality of bottom parts;
a plurality of first sidewall portions disposed on both sides of the bottom parts opposite to each other in the second direction and extending in the first direction; and
a plurality of second sidewall portions disposed on one side of each of the bottom parts opposite to each other in the first direction and extending in the second direction, the one side being spaced apart from the first hinge, and
wherein both sides of the moving plates opposite to each other in the second direction are disposed in sliding grooves defined on inner surfaces facing each other of the first sidewall portions and extending in the first direction, and slide in the first direction.

13. The electronic device of claim 12, wherein a distance between one side of each of the moving plates opposite to each other in the first direction and the second sidewall portions in a folded state is greater than a distance between the one side of each of the moving plates and the second sidewall portions in an unfolded state, and
wherein the one side of each of the moving plates opposite to each other in the first direction is a side spaced apart from the second hinge.

14. The electronic device of claim 12, further comprising:
a plurality of main plates fixed to interiors of the accommodation grooves and coupled to the first hinge,
wherein, when the main plates rotate about the first rotating axis, the housings rotate about the first rotating axis.

15. The electronic device of claim 14, wherein in a folded state, a distance between one side of each of the moving plates opposite to each other in the first direction and the second sidewall portions is greater than a distance between one side of each of the main plates opposite to each other in the first direction and the second sidewall portions, and
wherein the one side of each of the moving plates opposite to each other in the first direction is a side spaced apart from the second hinge, and the one side of each of the main plates opposite to each other in the first direction is a side spaced apart from the first hinge.

16. The electronic device of claim 14, wherein the main plates include:
a plurality of planarization parts having a plane defined by the second direction and the first direction; and
a plurality of connection parts disposed adjacent to sides of the planarization parts opposite to each other in the first direction, and
wherein the connection parts are disposed in grooves defined in the first hinge, the grooves have a curved shape, and the grooves are disposed in the second direction and are symmetrical to each other in the second direction.

17. The electronic device of claim 20, wherein the moving plates include:
a plurality of planarization parts having a plane defined by the second direction and the first direction; and
a plurality of connection parts disposed adjacent to sides of the planarization parts opposite to each other in the first direction, and
wherein the connection parts are disposed in grooves defined in the second hinge, the grooves have a curved shape, and the grooves are disposed in the second direction and are symmetrical to each other in the second direction.

18. An electronic device, comprising:
a display device configured to be folded or unfolded with respect to a folding axis extending in a second direction;
a power supply configured to provide power to the display device; and
a hinge mechanism in which a plurality of accommodation grooves configured to accommodate the display device are defined,
wherein the hinge mechanism includes:
a plurality of housings defining the accommodation grooves and disposed in a first direction intersecting the second direction;
a first hinge disposed between the housings and defining a first rotating axis extending in the second direction;
a second hinge disposed between the housings and defining a second rotating axis extending in the second direction;
a plurality of main plates disposed inside the accommodation grooves, coupled to the first hinge, and configured to rotate about the first rotating axis; and
a plurality of moving plates disposed on the main plates inside the accommodation grooves, coupled to the second hinge, and configured to rotate about the second rotating axis, and
wherein among the first rotating axis and the second rotating axis, the first rotating axis is disposed at a greater height than the second rotating axis.

19. The electronic device of claim 18, wherein a distance between one side of each of the main plates opposite to each other in the first direction and one side of each of the moving plates opposite to each other in the first direction in a folded state is greater than a distance between the one side of each of the main plates and the one side of each of the moving plates in an unfolded state, and
wherein the one side of each of the main plates is a side spaced apart from the first hinge, and the one side of each of the moving plates is a side spaced apart from the second hinge.

20. The electronic device of claim 19, wherein, in the folded state, a height of edges of the main plates is greater than a height of edges of the moving plates.
